(19) United States
(12) Patent Application Publication
(10) Pub. No.: US 2006/0117580 A1
(43) Pub. Date: Jun. 8, 2006

(54) Power tool and method of operating the same

(76) Inventors: David P. Serdynski, Waukesha, WI (US); Boyd J. Miller, Mequon, WI (US); Scott D. Bublitz, Hartland, WI (US); Troy C. Thorson, Waukesha, WI (US); Thomas R. Bednar, Pewaukee, WI (US); David B. Griep, Rubicon, WI (US)

Correspondence Address: MICHAEL BEST & FRIEDRICH, LLP, 100 E WISCONSIN AVENUE, MILWAUKEE, WI, 53202, US

(21) Appl. No.: 11/250,931

(22) Filed: Oct. 14, 2005

Related U.S. Application Data
(60) Provisional application No. 60/619,788, filed on Oct. 16, 2004.
(60) Provisional application No. 60/626,013, filed on Nov. 5, 2004.
(60) Provisional application No. 60/626,230, filed on Nov. 9, 2004.
(60) Provisional application No. 60/643,396, filed on Jan. 12, 2005.

(51) Int. Cl. B23D 49/16; B27B 19/00

(52) U.S. Cl. 30/392

(57) ABSTRACT

In some embodiments, the invention provides a reciprocating saw including a reciprocatable spindle for supporting a saw blade for reciprocating sawing movement and a body housing a motor and a drive mechanism driven by the motor, the drive mechanism selectively driving the spindle, the body having a forward end supporting the spindle, and a battery connectable to the body and having a forward-most point and a lower surface spaced rearwardly from the forward-most point.

### RELATED APPLICATIONS

The present invention claims the benefit of prior-filed, co-pending provisional patent application Ser. No. 60/619,788, filed Oct. 16, 2004, the entire contents of which is hereby incorporated by reference.

The present patent application also claims the benefits of prior filed co-pending U.S. provisional patent application Ser. No. 60/626,013, filed on Nov. 5, 2004; Ser. No. 60/626,230, filed on Nov. 9, 2004 and Ser. No. 60/643,396, filed on Jan. 12, 2005, the entire contents of all of which are hereby incorporated by reference.

The present patent application also claims the benefit of prior filed co-pending U.S. patent application Ser. No. 10/720,027, filed on Nov. 20, 2003, which claims the benefits of prior filed co-pending U.S. provisional patent application Ser. No. 60/428,358, filed on Nov. 22, 2002; Ser. No. 60/428,450, filed on Nov. 22, 2002; Ser. No. 60/428,452, filed on Nov. 22, 2002; Ser. No. 60/440,692, filed on Jan. 17, 2003; Ser. No. 60/440,693, filed on Jan. 17, 2003; Ser. No. 60/523,716, filed on Nov. 19, 2003; and Ser. No. 60/523,712, filed on Nov. 19, 2003, the entire contents of all of which are hereby incorporated by reference.

The present patent application also claims the benefit of prior filed co-pending U.S. patent application Ser. No. 10/719,680, filed on Nov. 20, 2003, which claims the benefits of prior filed co-pending U.S. provisional patent application Ser. No. 60/428,358, filed on Nov. 22, 2002; Ser. No. 60/428,450, filed on Nov. 22, 2002; Ser. No. 60/428,452, filed on Nov. 22, 2002; Ser. No. 60/440,692, filed on Jan. 17, 2003; Ser. No. 60/440,693, filed on Jan. 17, 2003; Ser. No. 60/523,716, filed on Nov. 19, 2003; and Ser. No. 60/523,712, filed on Nov. 19, 2003, the entire contents of all of which are hereby incorporated by reference.

The present patent application also claims the benefit of prior filed co-pending U.S. patent application Ser. No. 10/721,800, filed on Nov. 24, 2003, which claims the benefits of prior filed co-pending U.S. provisional patent application Ser. No. 60/428,356, filed on Nov. 22, 2002; Ser. No. 60/428,358, filed on Nov. 22, 2002; Ser. No. 60/428,450, filed on Nov. 22, 2002; Ser. No. 60/428,452, filed on Nov. 22, 2002; Ser. No. 60/440,692, filed on Jan. 17, 2003; Ser. No. 60/440,693, filed on Jan. 17, 2003; Ser. No. 60/523,712, filed on Nov. 19, 2003; and Ser. No. 60/523,716, filed on Nov. 19, 2003, the entire contents of all of which are hereby incorporated by reference.

The present patent application also claims the benefit of prior filed co-pending U.S. patent application Ser. No. 11/138,070, filed on May 24, 2005.

The present patent application also claims the benefit of prior filed co-pending U.S. patent application Ser. No. 11/165,615, filed Jun. 22, 2005, the entire contents of which is hereby incorporated by reference.

### FIELD OF THE INVENTION

The present invention relates to power tools and power tool accessories and, more particularly, to a reciprocating saw and accessories for reciprocating saws.

### SUMMARY

Power tools, such as reciprocating saws, are used to work on or cut a variety of objects, such as metal pipes, wood, drywall, etc. Such saws typically include a housing and a spindle mounted in the housing for reciprocating motion along an axis that is parallel to the longitudinal extent of the spindle. An electric motor provides power to the spindle through a mechanical reciprocating device that converts the rotary motion of a motor shaft to reciprocating motion.

In some constructions and in some aspects, a power tool, such as a reciprocating saw, generally includes a spindle for supporting a tool element, a body housing a motor and a drive mechanism driven by the motor, the drive mechanism selectively driving the spindle, the body having a forward end supporting the spindle and a rearward end, a grip connected to the rearward end of the body and being engageable by a hand of an operator, and a battery supported by the grip and being electrically connectable to the motor to supply power to the motor. In some constructions, the battery is contoured to avoid interference with a workpiece during plunge cutting. In some constructions, the power tool housing (e.g., the handle) and the battery are arranged to avoid interference between the battery and a workpiece during plunge cutting.

In some constructions and in some aspects, a power tool, such as a reciprocating saw, generally includes a spindle for supporting a tool element, a body housing a motor and a drive mechanism driven by the motor, the drive mechanism selectively driving the spindle, the body having a forward end supporting the spindle and a rearward end, a grip connected to the rearward end of the body and being engageable by a hand of an operator, a battery supported by the grip and being electrically connectable to the motor to supply power to the motor, a variable speed switch supported by the grip and operable to control the rotational speed of the motor, a trigger extending outwardly from the grip and engageable to operate the variable speed switch, and a limiting switch positioned adjacent to the variable speed switch and being operable to limit movement of the trigger with respect to the variable speed switch to limit the speed of the motor.

In addition, in some constructions and in some aspects, a power tool generally includes a housing, a spindle for supporting a tool element, a drive shaft rotatably supported in the housing, a counterweight mounted in the housing for reciprocating movement relative to the housing, a pair of rods mounted in the housing for supporting the counterweight, and a drive mechanism connected to the spindle for reciprocating the spindle relative to the housing and connected to the counterweight for reciprocating the counterweight relative to the housing. In some constructions and in some aspects, the counterweight defines an axially extending opening and an axially extending slot. In such constructions, to movably support the counterweight, one rod extends axially through the opening, and the other rod extends axially through the slot.

In some constructions and in some aspects, a power tool generally includes a body housing a motor, a drive mechanism driven by the motor, and a lubrication system. The lubrication system is housed in the body and generally includes a tank. The tank houses a volume of lubricant and has a port or drain communicating between the lubricant and the drive mechanism. During operation of the power tool, lubricant is forced out of the tank onto the drive mechanism to lubricate the drive mechanism.

In other constructions and in other aspects, a power tool, such as a reciprocating saw, generally includes a body, a spindle supported in the body for reciprocating movement with respect to the body, and a sealing arrangement. The sealing arrangement generally includes an elastomeric seal positioned on the spindle and movable along the spindle to wipe lubricant along the spindle toward the drive mechanism.

In addition, in some constructions and in some aspects, a storage assembly may be removably supportable on a power tool, such as a reciprocating saw, and may generally include a body defining a storage space and having a first portion and a second portion removably connected to the first portion for movement between a closed position, in which the first and second portions substantially enclose the storage space, and an opened position, in which at least a portion of the second portion is spaced a distance from the first portion.

Further, in some constructions and in some aspects, a power tool, such as a reciprocating saw, generally includes a housing, a spindle operable to support a tool element, a motor, a drive mechanism selectively powered by the motor and operable to drive the spindle, and a support member connectable to the housing and operable to support the power tool on a support.

Independent features and independent advantages of the present invention will become apparent to those skilled in the art upon review of the following detailed description and drawings.

### BRIEF DESCRIPTION OF THE DRAWINGS

In the drawings, wherein like reference numerals indicate like parts:

FIG. 1 is a front perspective view of a power tool, such as a reciprocating saw;

FIG. 2 is another front perspective view of the tool of FIG. 1;

FIG. 3 is a side view of the tool of FIG. 1;

FIG. 4 is a top view of the tool of FIG. 1;

FIG. 5 is a bottom view of the tool of FIG. 1;

FIG. 6 is a front view of the tool of FIG. 1;

FIG. 7 is a rear view of the tool of FIG. 1;

FIG. 8 is a cross-section view taken along line 8-8 of FIG. 7;

FIG. 9 is a cross-section view taken along line 9-9 of FIG. 8;

FIG. 10 is a perspective view of the tool of FIG. 1, illustrating a plunge cutting operation;

FIG. 11 is an exploded perspective view of a portion of the tool of FIG. 1;

FIG. 11A is an enlarged cross sectional view of the tool of FIG. 1;

FIG. 11B is an enlarged perspective view of a trigger limiting lever of the tool of FIG. 1;

FIG. 11C is a top view of the trigger limiting lever shown in FIG. 11B;

FIG. 11D is a side view of the trigger limiting lever shown in FIG. 11B;

FIG. 11E is a rear view of the trigger limiting lever shown in FIG. 11B;

FIG. 11F is a cross-sectional view of the trigger limiting taken along line 11F-11F of FIG. 11E;

FIG. 12 is a side view of a drive assembly of a power tool, such as a reciprocating saw;

FIG. 13 is a rear view of the drive assembly shown in FIG. 12;

FIG. 14 is an exploded perspective view of a portion of the drive assembly shown in FIG. 12;

FIG. 15 is a side view of a counterweight of the drive assembly shown in FIG. 12;

FIG. 16 is a front view of the counterweight shown in FIG. 15;

FIG. 17 is a front view of a wobble plate of the drive assembly shown in FIG. 12;

FIG. 18 is a cross-section view taken along line 18-18 of FIG. 17;

FIG. 19 is a perspective view of the wobble plate of FIG. 17;

FIG. 20 is a perspective view of a spindle of the drive assembly shown in FIG. 12;

FIG. 21 is a top view of the spindle shown in FIG. 20;

FIG. 22 is a cross-sectional view of the spindle taken along line 22-22 of FIG. 21;

FIG. 23 is a cross-sectional view taken along line 23-23 of FIG. 21;

FIG. 24 is an enlarged perspective view of a keyless blade clamp assembly of a power tool, such as a reciprocating saw;

FIG. 25 is a top view of a portion of the keyless blade clamp assembly shown in FIG. 24;

FIG. 26 is a cross-sectional view taken along line 26-26 of FIG. 25;

FIG. 27 is a front view of a power tool, such as a reciprocating saw, including an alternate construction of a keyless blade clamp assembly;

FIG. 28 is a schematic illustrating a side view of a lubrication system of a power tool, such as a reciprocating saw;

FIG. 29 is a cross-sectional view of a portion of a power tool, such as a reciprocating saw, including a spindle and a sealing ring;

FIG. 30 is a front view of the sealing ring of FIG. 29;

FIG. 31 is a side view of the sealing ring of FIG. 29;

FIG. 32 is a cross-sectional view taken along line 32-32 of FIG. 30;

FIG. 33 is an enlarged cross-sectional view taken along line 33-33 of FIG. 32;

FIG. 34 is cross-sectional view of a portion of a power tool, such as a reciprocating saw, including a spindle and an alternate construction of a sealing ring;

FIG. 35 is a front view of the sealing ring of FIG. 34;

FIG. 36 is an enlarged cross-sectional view taken along line 37-37 of FIG. 36;

FIG. 37 is a side view of a power tool, such as a reciprocating saw, and a storage assembly in a closed condition;

FIG. 38 is a side view of the storage assembly of FIG. 37 in an opened condition;

FIG. 39 a side view of a power tool, such as a reciprocating saw, and an alternate construction of a storage assembly with the storage assembly in a closed condition;

FIG. 40 is a side view of the storage assembly of FIG. 39 in an opened condition;

FIG. 41 is a side view of a power tool, such as a reciprocating saw, and a mounting and carrying hook;

FIG. 42 is a perspective view of a portion of an alternate construction of a power tool, such as a reciprocating saw;

FIG. 43 is a cross-sectional view taken along line 43-43 of FIG. 42;

FIG. 44 is a partial cross-sectional view of the tool of FIG. 42;

FIG. 45 is a perspective view of an alternate construction of a power tool, such as a reciprocating saw;

FIG. 46 is a side view of the tool of FIG. 45;

FIG. 47 is a cross-sectional view of the tool of FIG. 45;

FIG. 48 is a side view of an alternate construction of a portion of a power tool, such as a reciprocating saw;

FIG. 49 is an exploded perspective view of the housing portion of the tool of FIG. 48;

FIG. 50 is a cross-sectional view of the housing portion of the tool of FIG. 48;

FIG. 51 is a perspective view of a portion of a power tool, such as a reciprocating saw, including an information or identification plate;

FIG. 52 is a perspective view of the housing portion of the tool and the identification plate of FIG. 51;

FIG. 53 is a front view of the housing portion of the tool of FIG. 51;

FIG. 54 is a cross-sectional view of an alternate construction of a drive assembly of a power tool, such as a reciprocating saw; and

FIG. 55 is another cross-sectional view of the drive assembly of the tool of FIG. 54.

Before any features and at least one construction of the invention are explained in detail, it is to be understood that the invention is not limited in its application to the details of construction and the arrangements of the components set forth in the following description or illustrated in the drawings. The invention is capable of other constructions and of being practiced or being carried out in various ways. Also, it is understood that the phraseology and terminology used herein is for the purpose of description and should not be regarded as limiting. The use of “including”, “having” and “comprising” and variations thereof herein is meant to encompass the items listed thereafter and equivalents thereof as well as additional items.

Although references may be made below to directions, such as upper, lower, downward, upward, rearward, bottom, front, rear, etc., in describing the drawings, these references are made relative to the drawings (as normally viewed) for convenience. These directions are not intended to be taken literally or limit the present invention in any form. In addition, terms such as “first”, “second”, and “third” are used herein for purposes of description and are not intended to indicate or imply relative importance or significance.

### DETAILED DESCRIPTION

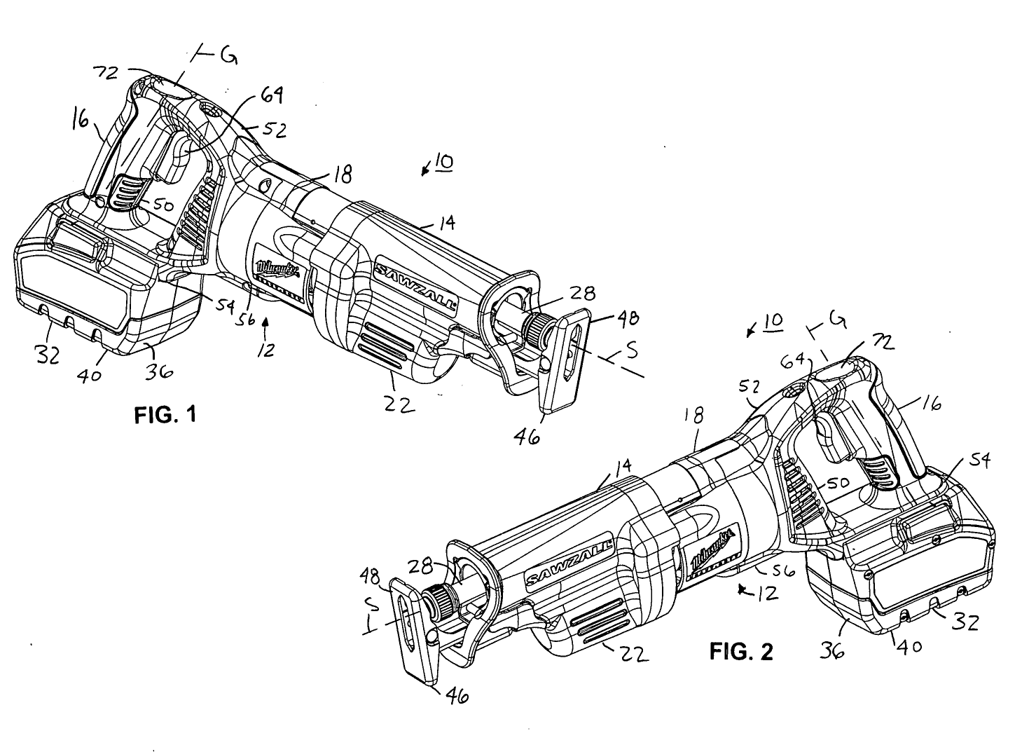

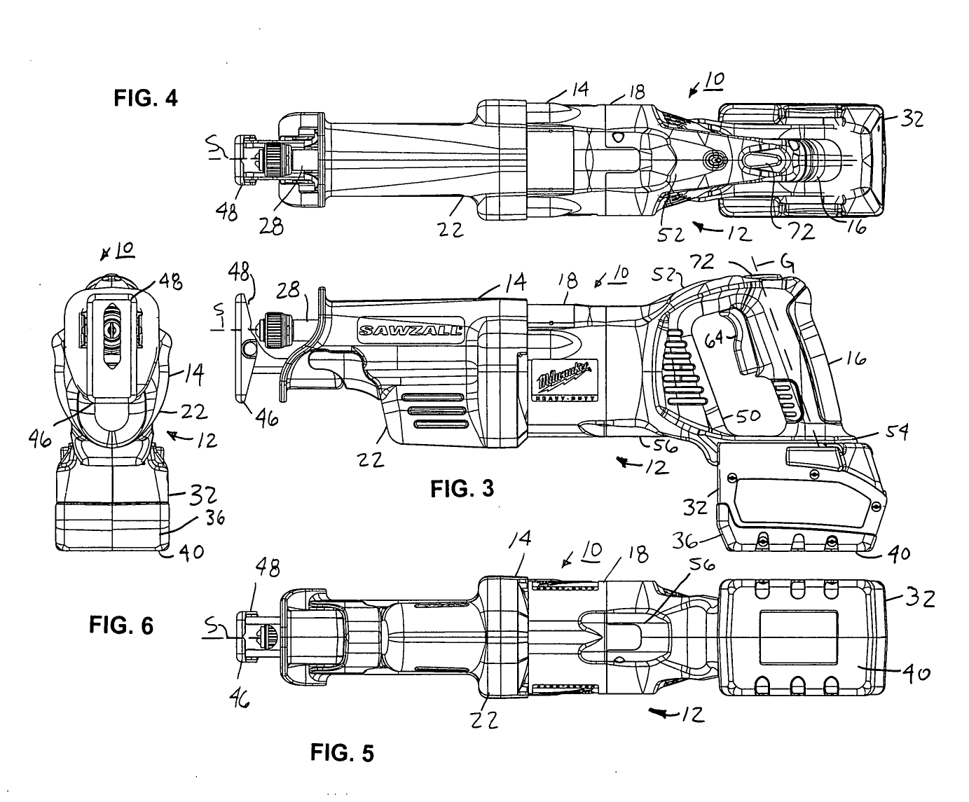

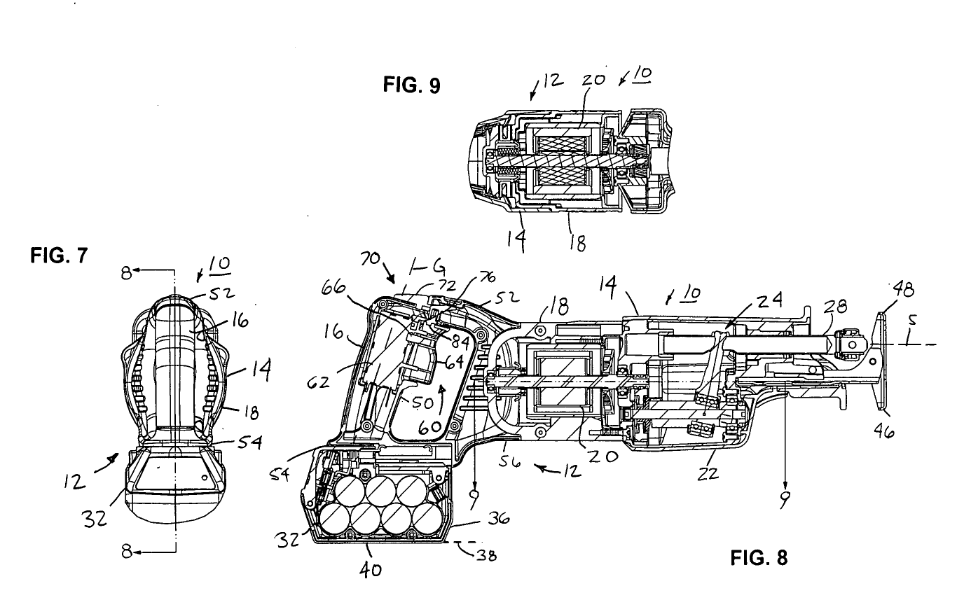

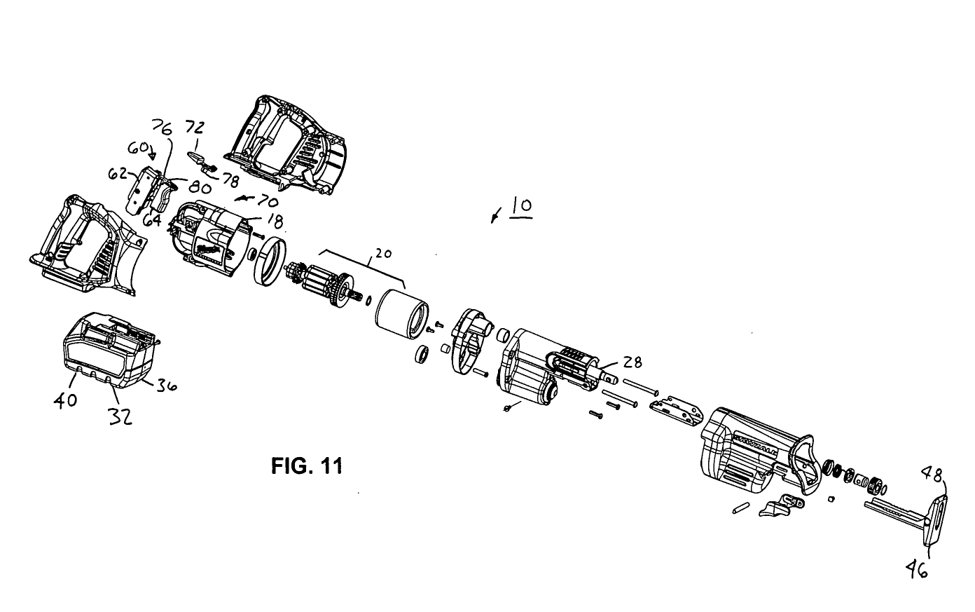

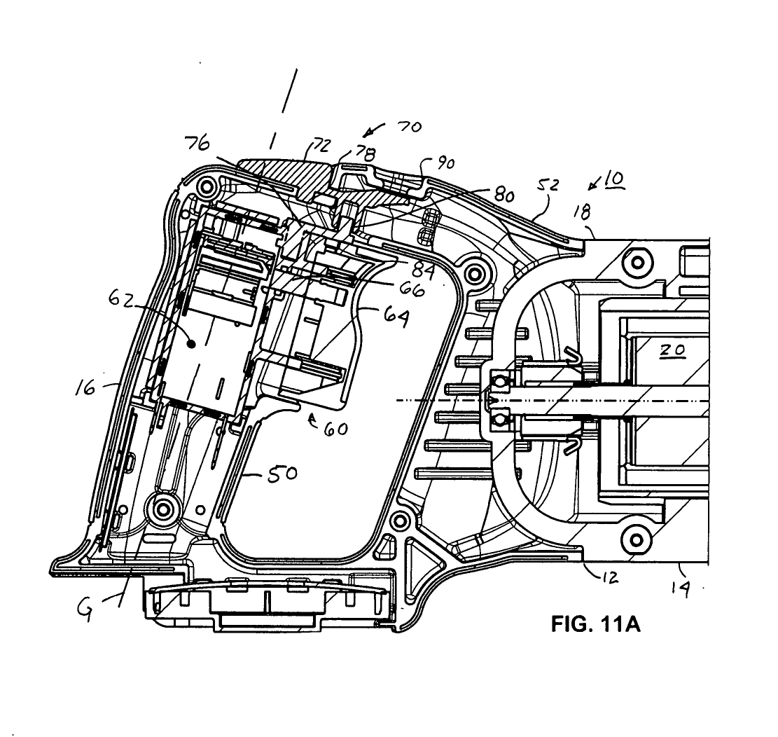

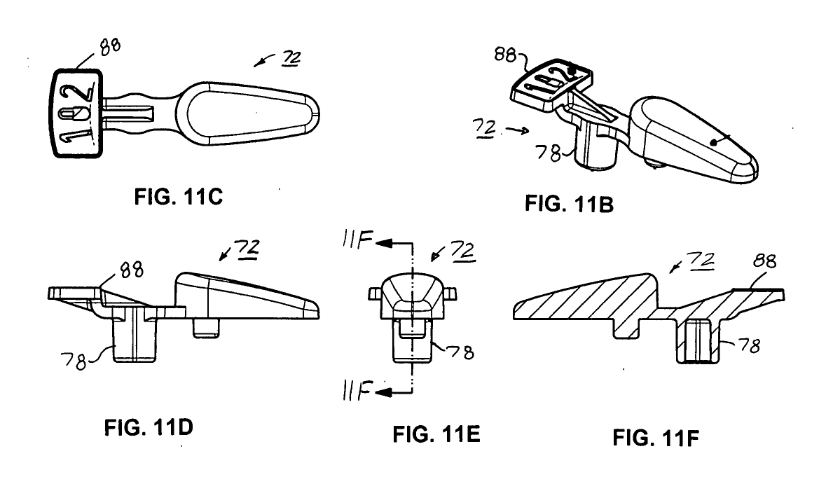

FIGS. 1-11F illustrate a power tool, such as a reciprocating saw 10, embodying independent aspects of the present invention. The reciprocating saw 10 includes a housing assembly 12 having a body 14 and a main operator's handle portion or hand grip 16 connected to the a rearward portion 18 of the body 14.

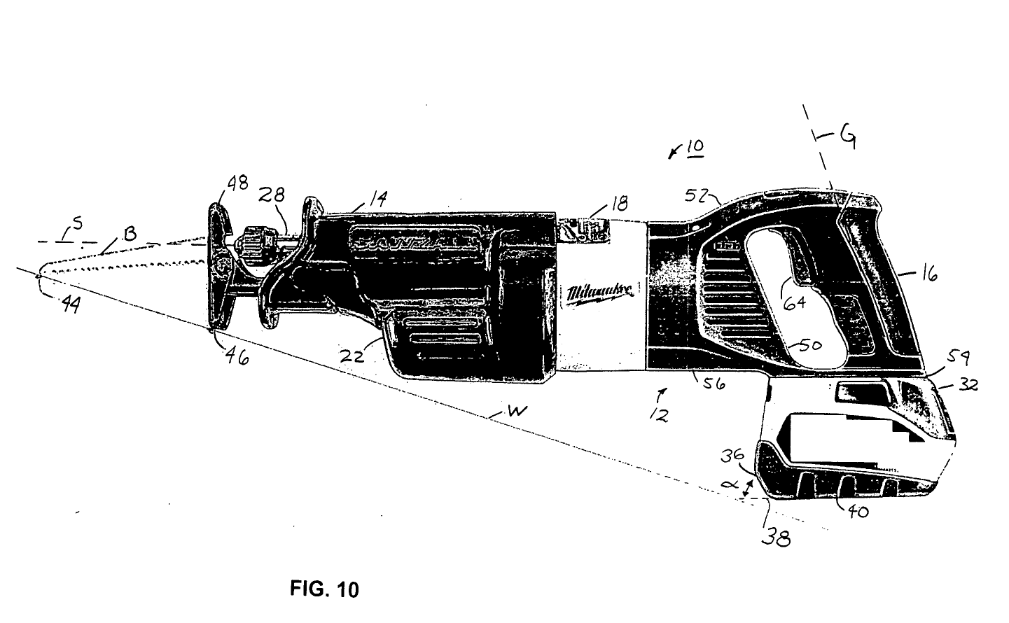

The rearward portion 18 of the body 14 houses a motor 20 and a forward portion 22 of the body 14 houses a drive mechanism 24. The motor 20 and the drive mechanism 24 are operable to reciprocate a spindle 28, and the spindle 28 is adapted to support a saw blade B (shown in FIG. 10) for cutting a workpiece W (also shown in FIG. 10).

The motor 20 and the drive mechanism 24 operate to reciprocate the spindle 28 generally along a spindle axis S and, in some constructions, in an orbital motion or in a rocking motion relative to the body 14. An example of an orbital drive mechanism is shown and described in U.S. Pat. No. 6,249,979, issued Jun. 26, 2001, the entire contents of which is hereby incorporated by reference. An example of a rocker drive mechanism is shown and described in U.S. Pat. No. 6,508,151, issued Jan. 21, 2003, the entire contents of which is hereby incorporated by reference.

In the illustrated construction of FIGS. 1-11F and in some aspects, the motor 20 is an electric motor that is connectable to a power source, such as a battery 32, by an electrical circuit. However, in other constructions (not shown), the motor 20 may be powered by another power source, such as, for example, by a power cord connected to an AC power source or to a DC power source.

As shown in FIGS. 1-8 and 10-11A, the battery 32 is removably connected to a lower end of the hand grip 16 and, in the illustrated construction, is slidably attached to the hand grip 16 in a direction generally perpendicular to a grip axis G. The battery 32 and the electrical circuit include connectors (not shown) which electrically connect the battery 32 to the electrical circuit and which physically connect the battery 32 to the hand grip 16.

In the illustrated construction of FIGS. 1-11F and in some aspects, the battery 32 has a relatively compact profile and is supported on a lower-most and rearward-most portion of the body 14 (i.e., the battery 32 is supported below the hand grip 16). In this manner, the battery 32 is positioned to avoid or minimize contact or interference with the workpiece W during operation of the reciprocating saw 10.

As shown in FIGS. 1-11F, the battery 32 is also contoured to avoid or minimize contact or interference with the workpiece W during operation of the reciprocating saw 10. More particularly, in the illustrated construction, a forward surface 36 of the battery 32 and an imaginary plane 38 extending forwardly from a bottom surface 40 of the battery 32 define an angle α (shown in FIG. 10) of between about 15 degrees and about 45 degrees. As shown in FIG. 2, the forward surface 36 of the battery and the bottom surface 40 of the battery 32 define an obtuse angle β of between about 91 degrees and about 179 degrees.

In some constructions, such as the illustrated construction of FIGS. 1-11F, the bottom surface 40 of the battery 32 can be arranged rearwardly from a forward-most portion 41 of the battery 32. In addition, in some constructions, such as the illustrated construction of FIGS. 1-11F, the battery 36 can include a first forward surface 36a oriented an obtuse angle with respect to a second forward surface 36b. This contoured shape minimizes any contact between the battery 32 and the workpiece W during most cutting operations.

For example, to initiate a plunge cut, an operator can orient the reciprocating saw 10 and the saw blade B in an orientation in which a forward-most point 44 of the saw blade B and a lower-most portion 46 of a shoe support 48 contact the workpiece W. More particularly, to initiate a plunge cut, an operator orients the reciprocating saw 10 in an orientation in which the spindle axis S and the workpiece W define an acute angle. The operator then operates the reciprocating saw 10 to cut a hole in the workpiece W. As the saw blade B cuts through the workpiece W, the operator pivots the saw 10 upwardly toward a position in which the spindle axis S is substantially perpendicular to the workpiece W. During initiation of such a plunge cutting operation, the orientation of the battery 32 with respect to the body 14 (i.e., with the battery 32 being connected to a rearward-most and a lower-most portion of the body 14) and the contoured forward surface 36 of the battery 32 prevent the battery 32 from contacting the workpiece W and from interfering with the operation of the reciprocating saw 10.

As shown in FIGS. 1-11F, the hand grip 16 defines an opening 50 for an operator's fingers. During operation of the reciprocating saw 10, an operator wraps his hand at least partially around the hand grip 16 and inserts one or more fingers into the opening 50 to operate the trigger 64 (described below).

In the illustrated construction of FIGS. 1-11F and in some aspects, the hand grip 16 includes an upper surface 52, which slopes upwardly and rearwardly from a rearward portion 18 of the body 14, and a lower surface 54, which is aligned with or substantially aligned with a lower surface 56 of the body 14. In these constructions and in these aspects, the hand grip 16 and the opening 50 can be sufficiently sized so that an operator can wrap his entire hand around the hand grip 16 and can insert four fingers into the opening 50. Moreover, in these constructions and in these aspects, because the lower surface 54 is aligned with or substantially aligned with a lower surface 56 of the body 14, an operator can position the reciprocating saw 10 relatively close to a workpiece W so that only the height of the battery 32 separates the lower surface 54 of the body 14 and the workpiece W. In such constructions, the size of the hand grip 16 and opening 50 is maintained while contact or interference between the battery and the workpiece W is avoided or minimized during operation of the reciprocating saw 10.

As shown in FIGS. 1-11F, the reciprocating saw 10 also includes a switch assembly 60, which is operable to connect the motor 20 to the power source (e.g., the battery 32) and is supported on the hand grip 16. In some constructions and in some aspects, the switch assembly 60 includes an on/off switch 62 having a trigger 64 and a plunger 66 extending between the trigger 64 and the on/off switch 62. The trigger 64 extends outwardly through an opening in the hand grip 16 for engagement by an operator's finger. In the illustrated construction of FIGS. 1-11F and in some aspects, the trigger 64 extends outwardly through an opening in the hand grip 16 for engagement by two of the operator's fingers. In these constructions and in these aspects, the trigger 64 is relatively elongated in a direction substantially parallel to the grip axis G.

In the illustrated construction of FIGS. 1-11F and in some aspects, the on/off switch 62 is a variable speed switch which, as the trigger 64 and the plunger 66 are moved rearwardly from an extended position (shown in FIGS. 1-10) toward a depressed position (not shown), supplies gradually increasing power from the power source to the motor 20. In these constructions and in these aspects, the operator squeezes the trigger 64 with one or more fingers to move the trigger 64 and the plunger 66 from the extended position toward a depressed or recessed position to operate the motor 20.

In some constructions and in some aspects, the reciprocating saw 10 also includes a trigger limiting assembly 70 which is operable to restrict or limit movement of the trigger 64 and the plunger 66. In the illustrated construction of FIGS. 1-11F and in some aspects, the trigger limiting assembly 70 includes a trigger limiting switch 72 which is supported on the upper surface 52 of the hand grip 16 and is pivotable relative to the hand grip 16 between a plurality of positions. As shown in FIGS. 1-11F, the trigger limiting switch 72 is positioned along the grip axis G and above the trigger 64. In this manner, an operator can pivot the trigger limiting switch 72 with a thumb while operating the trigger 64 with one or more fingers of the same hand.

In the illustrated construction of FIG. 1-11F and in some aspects, the trigger limiting assembly 70 also includes a limiting arm 76, which extends outwardly from an upper portion of the on/off switch 62 and across an upper surface of the trigger 64. In these constructions and in these aspects, a first protrusion 78 extends downwardly from a lower portion of the trigger limiting switch 72 and cammingly engages an upwardly extending protrusion 80 on the limiting arm 76. In this manner, the trigger limiting switch 72 can pivot the limiting arm 76 relative to the on/off switch 62 between a plurality of positions.

In some constructions and in some aspects, the limiting arm 76 also includes a stop 84 (shown in FIG. 8), which extends downwardly from the limiting arm 76 and is selectively engageable with a portion of the trigger 64 to limit rearward motion of the trigger 64. In these constructions and in these aspects, an operator can pivot the trigger limiting switch 72 toward a first position, in which the trigger limiting switch 72 cammingly engages the limiting arm 76, moving the limiting arm 76 and the stop 84 out of engagement with the trigger 64 so that the trigger 64 can be fully depressed (e.g., a maximum or high speed position). Alternatively, the operator can pivot the trigger limiting switch 72 toward a second position, in which the trigger limiting switch 72 cammingly engages the limiting arm 76, moving the limiting arm 76 and the stop 84 into a position between the on/off switch 62 and the trigger 64 and preventing the trigger 64 and the plunger 66 from being fully depressed (e.g., a limited or low speed position).

In the illustrated construction of FIGS. 1-11F and in aspects in which the on/off switch 62 is a variable speed switch, an operator can pivot the trigger limiting switch 72 toward the first position to operate the reciprocating saw 10 at a number of operating speeds, including a high or maximum speed. Alternatively, the operator can pivot the trigger limiting switch 72 toward the second position to prevent the trigger 64 and the plunger 66 from being fully depressed so that the motor 20 can only be operated at low speeds.

In other constructions and in other aspects, the trigger limiting switch 72 is pivotable toward a third position, in which the trigger limiting switch 72 cammingly engages the limiting arm 76 and moves the limiting arm 76 and the stop 84 into engagement with the trigger 64, locking the trigger 64 and the plunger 66 in a fully extended position (e.g., a trigger lock off position). In these constructions and in these aspects, the trigger limiting assembly 70 is operable to lock the trigger 64 in a non-operating or off position.

In still other constructions and in other aspects, the trigger limiting switch 72 is pivotably connected to the upper surface 52 of the hand grip 16 for movement toward a number of intermediate positions, in which the trigger limiting switch 72 cammingly engages the limiting arm 76 and moves the limiting arm 76 and the stop 84 into a number of position between the on/off switch 62 and the trigger 64. In these constructions and in these aspects, the trigger limiting switch 72 can be moved between the intermediate positions so that the motor 20 can be operated at a number of different operating speeds.

The selectable operating speeds of the motor 20 can be optimized for various materials to be cut (e.g., high speed for wood, lower speed for metal, etc.). In addition, the operator can choose an operating speed based on a desired cutting operation (e.g., high speed for “rough” cutting operations, lower speed for precise cutting operations, etc.).

In the illustrated construction of FIGS. 1-11F and in some aspects, the trigger limiting switch 72 includes a forwardly extending flange 88 having indicia printed thereon, and the upper surface 52 of the grip 16 defines a viewing window 90. In some such constructions and in some such aspects, the indicia printed on the forwardly extending flange 88 correspond to the positions (e.g., the first, second, and/or locked positions) of the trigger limiting switch 72. In these constructions and in these aspects, the indicia printed on the forwardly extending flange 88 are viewable through the viewing window 90 so that an operator can determine the position of the trigger limiting switch 72 by viewing the visible indicia through the viewing window 90.

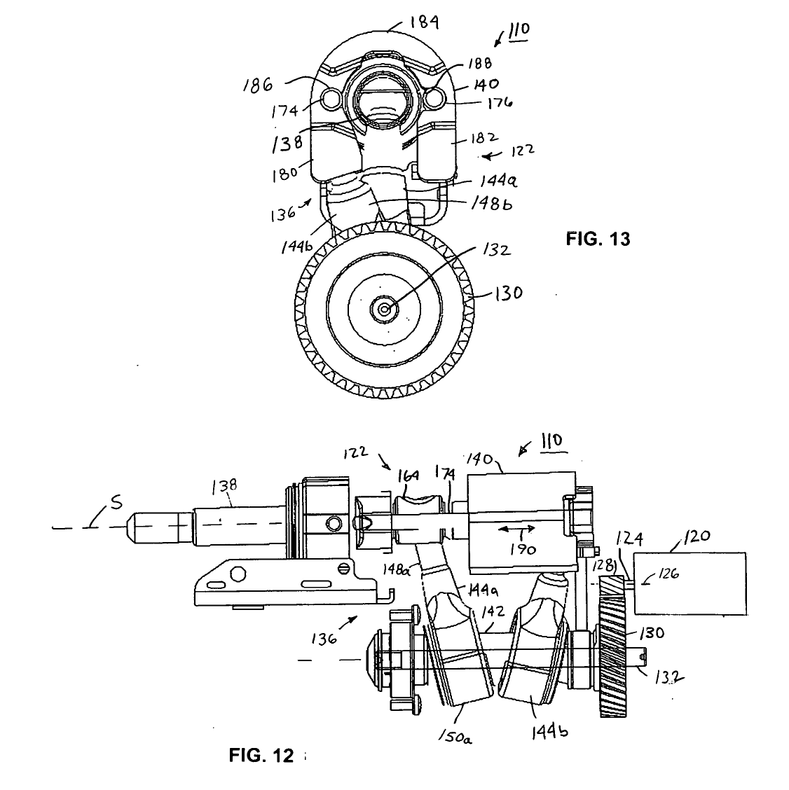

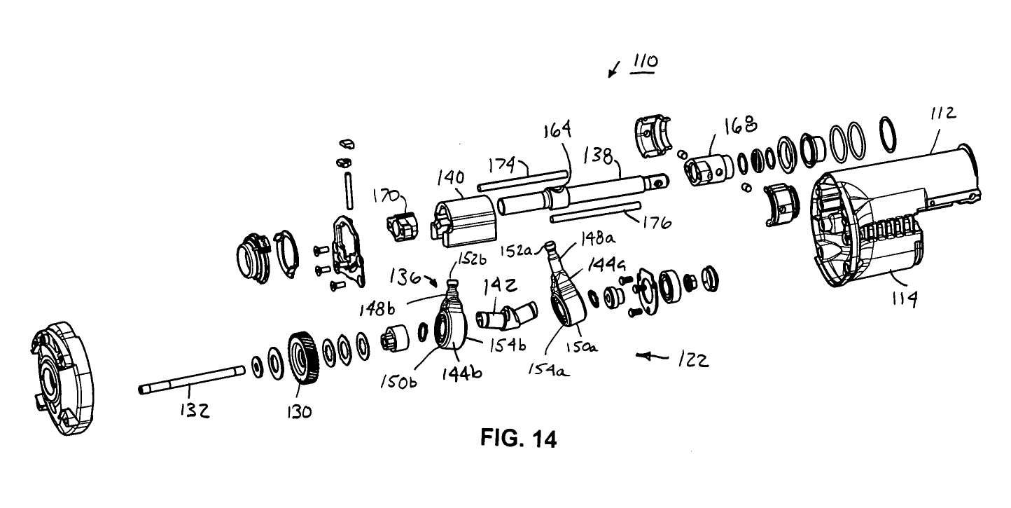

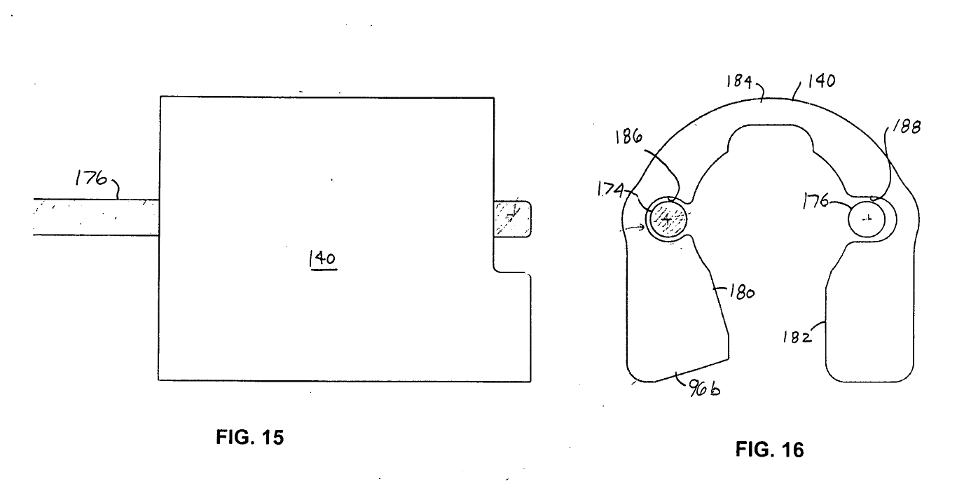

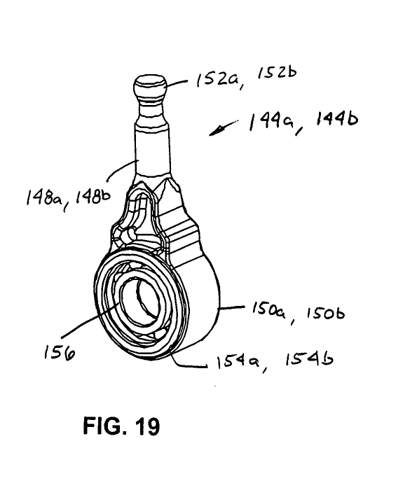

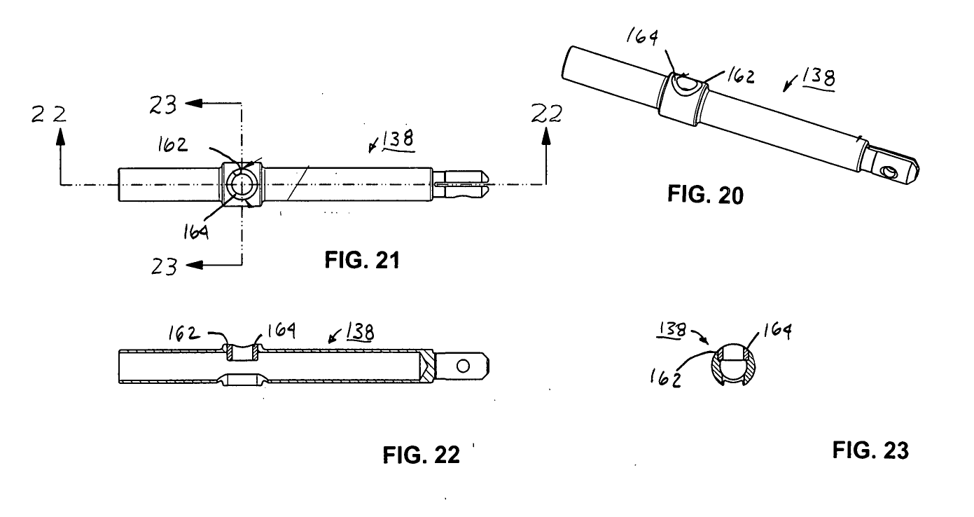

FIGS. 12-23 illustrate a drive assembly 110 for a power tool, such as a reciprocating saw, embodying independent aspects of the present invention. As shown in FIG. 14, the drive assembly 110 is supported in a forward portion 112 of a housing assembly 114 (partially shown) and includes a motor 120 and a drive mechanism 122. The motor 120 includes a drive shaft 124 defining a drive shaft axis 126. A pinion 128 is supported on an end of the drive shaft 124 and drivingly engages a gear 130 mounted on a gear shaft 132.

In the illustrated construction of FIGS. 12-23 and in some aspects, the drive mechanism 122 includes a wobble plate drive assembly 136 for driving a spindle 138 and for driving a counterweight 140. The wobble plate drive assembly 136 includes a wobble shaft 142 positioned over the gear shaft 132 and first and second drive arms or wobble plates 144a, 144b, which are eccentrically connected to the gear shaft 132.

The first or primary wobble plate 144a includes a drive arm 148a having a driven end 150a and a ball-shaped drive end 152a. The driven end 150a of the first wobble plate 144a defines an opening 154a for receiving the wobble shaft 142. In the construction illustrated in FIGS. 12-23, the first wobble plate 144a supports bearings 156 in the opening 154a, and the bearings 156 generally reduce friction between the first wobble plate 144a and the wobble shaft 142.

To secure the bearings 156 in the opening 154a and to prevent relative movement between an outer race of the bearings 156 and an inner surface of the opening 154a, the driven end 150a of the first wobble plate 144a is formed around the bearings 156. In the construction illustrated in FIGS. 12-23 and in some aspects, the driven end 150a of the first wobble plate 144a is pressed or swedge formed around the bearings 156. In these constructions and in these aspects, a portion of the driven end 150a is pressed around the bearings 156 to form lips 160 which hold the bearings 156 in the opening 154a.

The first wobble plate 144a engages the spindle 138 and operates to reciprocate the spindle 138 upon operation of the motor. The drive end 152a of the first wobble plate 144a is inserted into a bore 162 defined in the spindle 138 to form a spindle socket. In the illustrated construction of FIGS. 12-23 and in some aspects, a bushing 164 is inserted in the bore 162 between the drive end 152a of the first wobble plate 144a and the wall of the bore 162. In some constructions and in some aspects, the bushing 164 is laser welded in the bore 162 with a high-pulse laser and the spindle 138 and the bushing 164 are then heat-treated. The bushing 164 may be formed of a material which is different than the material of the spindle 138 and which has improved material characteristics (e.g., improved wear resistance, reduced friction, etc.).

The second or secondary wobble plate 144b includes a drive arm 148b having a driven end 150b and a ball-shaped drive end 152b. The driven end 150b of the second wobble plate 144b defines an opening 154b for receiving the wobble shaft 142. In the illustrated construction of FIGS. 12-23, the second wobble plate 144b supports bearings 156 in the opening 154b.

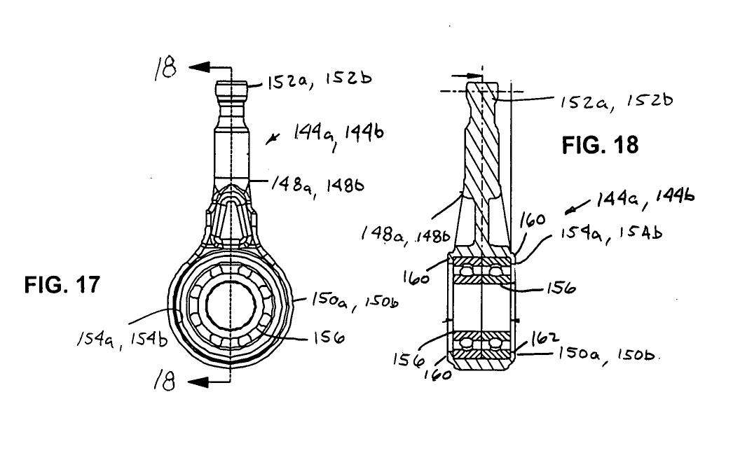

To secure the bearings 156 in the opening 154b and to prevent relative movement between an outer race of the bearings 156 and an inner surface of the opening 154b, the driven end 150b of the second wobble plate 144b is formed around the bearings 156. In the illustrated construction of FIGS. 17-19 and in some aspects, the driven end 150b of the second wobble plate 144b is pressed or swedge formed around the bearings 156, forming lips 160 which secure the bearings 156 in the opening 154b.

As shown in FIGS. 12-13, the drive end 152a of the second wobble plate 144b engages an opening in the counterweight 140 and operates to reciprocate the counterweight 140 upon operation of the motor. During operation of the drive assembly 110, the counterweight 140 provides a vibration-reducing force that at least partially counteracts the forces created by movement of the spindle 138. Accordingly, in the illustrated construction, the first and second wobble plates 144a, 144b are oriented to reciprocate the spindle 138 and the counterweight 140 in opposite directions.

As shown in FIGS. 12-14, the spindle 138 extends axially through the drive assembly 110 and is supported for reciprocating motion relative to the housing 114 along a spindle axis S. As shown in FIG. 14, a first bushing 168 is located in a forward portion of the housing 114 to support a forward end of the spindle 138 and a second bushing 170 is located in a rearward portion of the housing 114 to support a rearward end of the spindle 138.

In the construction illustrated in FIGS. 12-16 and in some aspects, the counterweight 140 is supported in the housing 114 for reciprocating movement relative to the housing 114 along two guide rods 174, 176, which extend axially through the forward portion 112 of the housing 114. In the construction illustrated in FIGS. 12-16, the rods 174, 176 are substantially parallel and are supported at opposite ends by the first and second bushings 168, 170. In other constructions (not shown) and in other aspects, the rods 174, 176 may converge inwardly, or alternatively, the rods 174, 176 may diverge outwardly from each other.

The counterweight 140 has a generally U-shaped cross-sectional shape and includes legs 180, 182, which extend downwardly from a central portion 184 of the counterweight 140. An opening 186 extends axially through the first leg 180 between forward and rearward ends of the first leg 180, and a slot 188 extends axially through the second leg 182 between forward and rearward ends of the second leg 182.

As shown in FIGS. 12-16, the rods 174, 176 extend through the opening 186 and the slot 188, respectively to support and guide the counterweight 140 as the counterweight 140 reciprocates along a travel path (represented by arrows 190 in FIG. 12) between a forward position (not shown) and a rearward position (shown in FIG. 12). The engagement between rod 174 and the aperture 186 and between rod 176 and the slot 188 also prevents the counterweight 140 from pivoting about either of the rods 174, 176.

The arrangement of the opening 186 and the slot 188 provides improved assembly and operation of the drive mechanism 110 and the counterweight 140. The configuration of the opening 186 prevents lateral movement of the rod 174 from the opening 186 but allows some relative lateral movement between the counterweight 140 and the rod 174 (e.g., to allow for manufacturing tolerances, misalignment of the components, etc.). The slot 188 is configured to allow lateral movement of the rod 176 into and out of the slot 188 during assembly and maintenance and to allow relative lateral movement between the counterweight 140 and the rod 174 (e.g., to allow for manufacturing tolerances, misalignment of the components, etc.).

In other constructions and in other aspects (not shown), the counterweight 140 can be fixedly supported in the housing 114. In these constructions and in these aspects, the counterweight 140 counterbalances movement of the spindle 138 and is non-movably secured to the housing 114. In still other constructions (not shown), the counterweight 140 may be driven independently of the spindle 138 by a separate counterweight drive mechanism.

It should be understood that, in other constructions (not shown), another drive mechanism, such as, for example, a crank arm drive, a scotch yoke drive, etc., may be provided to reciprocate the spindle 138 and/or the counterweight 140 (if a counterweight is provided). Suitable crank arm drive arrangements are shown and described in U.S. patent application Ser. No. 09/704,914, filed Nov. 2, 2000, U.S. patent application Ser. No. 10/742,969, filed Dec. 22, 2003, and U.S. patent application Ser. No. 10/874,890, filed Jun. 23, 2004, the entire contents of which are hereby incorporated by reference.

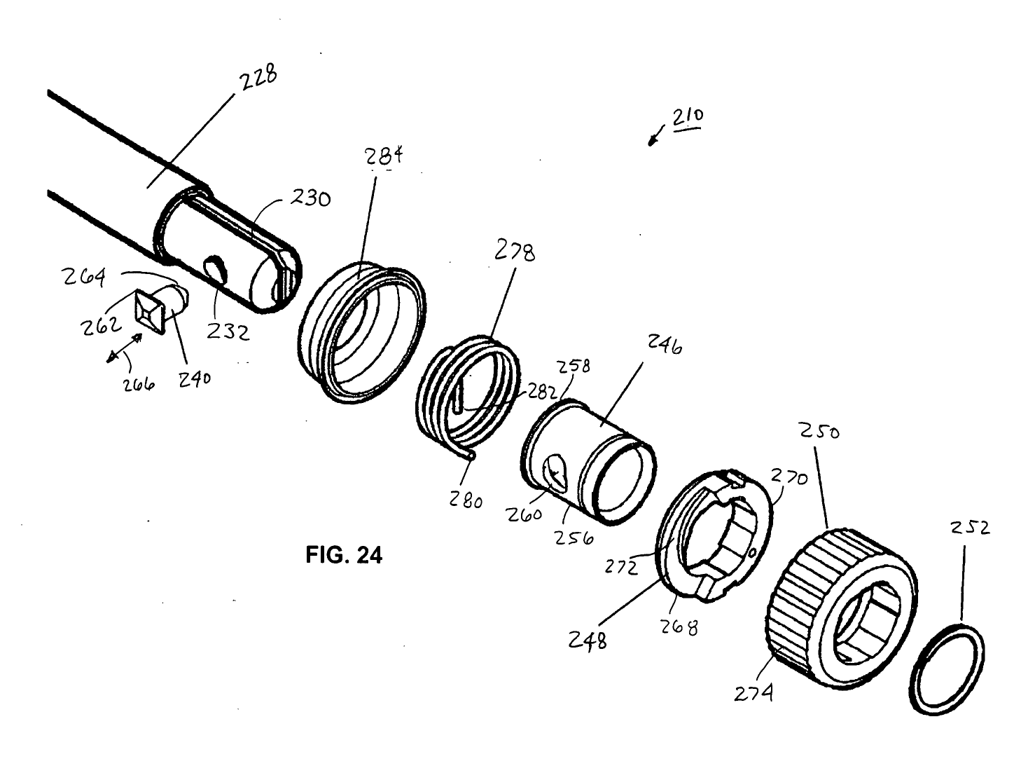

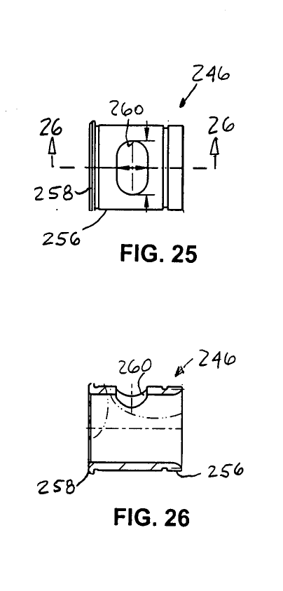

FIGS. 24-26 illustrate a keyless blade clamp assembly 210 mountable on a spindle 228 of a power tool, such as a reciprocating saw. The spindle 228 includes an axial slot 230 adapted to receive a saw blade and a radial slot 232 extending radially through the spindle 228 and communicating with the axial slot 230.

The blade clamp assembly 210 includes a pin 240, a sleeve 246, a locking ring or rear cam member 248, a collar or front cam member 250 and a retainer clip 252, which secures the sleeve 246, the rear cam member 248, and the front cam member 250 on the spindle 228. Components of blade clamp assembly 210 may be similar or identical to components shown and described in U.S. Pat. No. 6,209,208, issued Apr. 3, 2001, the entire contents of which is hereby incorporated by reference.

In the illustrated construction of FIGS. 24-26 and in some aspects, the sleeve 246 is positioned on an end of the spindle 228, and includes a cylindrical body portion 256 and a flange 258. A slot 260 extends radially through the body portion 256 and extends circumferentially through at least a portion of the body portion 256 (i.e., the slot 260 is elongated and has a generally ovular shape).

As shown in FIGS. 24-26 and in some aspects, the pin 240 includes a head portion 262 and a tapered or conical end 264. The pin 240 is positioned in the slot 260 and is radially movable relative to the spindle 228 (as indicated by arrow 266 in FIG. 24), between a locking position, in which at least a portion of the end 264 extends into the axial slot 230, and an unlocking or releasing position, in which the end 264 is substantially removed from the axial slot 230. When the locking pin 240 is in the locking position, the pin 240 moves circumferentially along the slot 260 so that wear is distributed along the length of the slot 260.

The rear cam member 248 is pivotably positioned over the sleeve 246 so that the flange 258 of the sleeve 246 limits rearward motion of the rear cam member 248. As shown in FIG. 24, the rear cam member 248 includes a base portion 268, a raised portion 270 and a ramp 272 extending between the base portion 266 and the raised portion 268.

The front cam member 250 is positioned over the sleeve 246 and the rear cam member 248 and includes an outer gripping surface 274. When the blade clamp 210 is assembled, the head portion 262 of the pin 240 extends radially outwardly and is positioned in a groove (not shown) defined between the ramp 272 of the rear cam member 248 and an inner surface of the front cam member 250.

The rear and front cam members 248, 250 are pivotable about the spindle 228 between a first position, in which the pin 240 is forced radially inwardly toward the locked position, and a second position, in which the pin 240 is allowed to move radially outwardly toward the unlocked position. More specifically, as the rear and front cam members 248, 250 are pivoted toward the first position, the head portion 262 of the pin 240 is moved circumferentially along the groove between and the ramp 270 of the rear cam member 248 and the inner surface of the front cam member 250, causing the pin 240 to move radially inwardly toward the axial slot 230 in the spindle 228. As the rear and front cam members 248, 250 are pivoted toward the second position, the head portion 262 of the pin 240 is moved circumferentially along the groove between the ramp 270 of the rear cam member 248 and the inner surface of the front cam member 250, causing the pin 240 to move radially outwardly away from the axial slot 230 in the spindle 228.

In the illustrated construction of FIGS. 24-26 and in some aspects, the blade clamp 210 also includes a spring 278 having a front leg 280 and a rear leg 282. In these constructions and in these aspects, the rear leg 282 is positioned in the axial slot 230 and the front leg 280 is positioned in an aperture (not shown) in the front cam member 250. In this manner, the spring 278 is operable to bias the rear and front cam members 248 toward the first position and to bias the pin 240 toward the locked position. The blade clamp 210 can also include a spring cover 284.

In operation, an operator grasps the gripping surface 274 of the of the front cam member 250 and pivots the front cam member 250 about the spindle 228 from the first position toward the second position, causing the pin 240 to move radially outwardly toward the releasing position. The operator then inserts a saw blade (not shown but substantially similar to that shown in FIG. 10) into the axial slot 230 and moves the front cam member 250 toward the second position, causing the pin 240 to move radially inwardly toward the locking position to secure the saw blade in the axial slot 230.

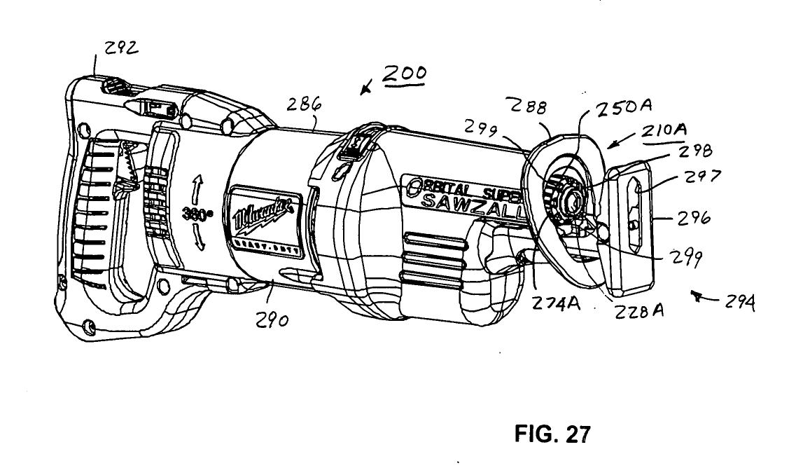

FIG. 27 illustrates a power tool, such as a reciprocating saw 200, including an alternate construction of the keyless blade clamp 210A. The keyless blade clamp 210A in FIG. 27 is similar in many ways to the illustrated construction of FIGS. 24-26 described above. Accordingly, with the exception of mutually inconsistent features and elements between the construction of FIG. 27 and the construction of FIGS. 24-26, reference is hereby made to the description above accompanying the construction of FIGS. 24-26 for a more complete description of the features and elements (and the alternatives to the features and elements) of the construction of FIGS. 24-26. Features and elements in the construction of FIG. 27 corresponding to features and elements in the construction of FIGS. 24-26 are identified by the same reference number and the letter “A”.

In the illustrated construction of FIG. 27 and in some aspects, the reciprocating saw 200 includes a tool body 286 having a forward end 288 and a rearward end 290 and a main operator's handle or hand grip 292 connected to the rearward end 290 of the body 286. The forward end 288 supports a spindle 228A adapted to receive a saw blade (not shown but similar to that shown in FIG. 10).

As shown in FIG. 27, the reciprocating saw 200 also includes an adjustable shoe assembly 294 connected to the forward end 288 of the body 286. Some components of the adjustable shoe assembly 294 may be similar to the components shown in U.S. Pat. No. 6,249,979.

In the illustrated construction of FIG. 27 and in some aspects, the adjustable shoe assembly 294 includes a shoe plate 296 having a surface for engaging a surface of a workpiece. The shoe plate 296 defines an aperture 297 through which the saw blade is extendable. The aperture 297 can also be dimensioned to accommodate an orbital path of the saw blade.

In operation, before a saw blade is inserted, an operator inserts one or more fingers between the forward end 288 of the tool body 286 and the shoe plate 296 and engages the front cam member 250A. With one or more fingers, the operator then rotates the front cam member 250A with respect to the spindle 228A toward a releasing position.

In some constructions and in some aspects, the front cam member 250A includes an outer gripping surface 274A so that the operator can more easily grip the front cam member 250A and can more easily rotate the cam member 250A toward the releasing position. In the illustrated construction of FIG. 27 and in some aspects, a forward end 298 of the cam member 250A includes a forward gripping surface 299 having a number of axially extending bumps or protrusions so that an operator can more easily grip the forward end 298 of the cam member 250A and can more easily rotate the cam member 250A toward the releasing position (even with the spindle 228A in a retracted position), or alternately, so that an operator can grasp the forward end 298 of the spindle 228A and move the spindle 228A axially toward an extended position before operating the keyless blade clamp 210A.

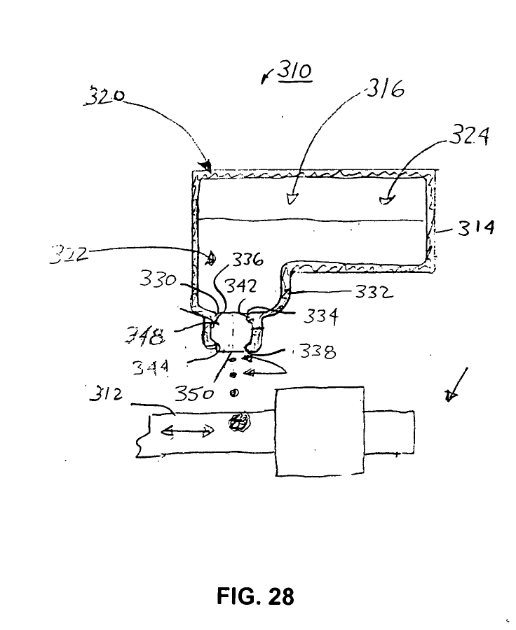

FIG. 28 illustrates a lubrication system 310 for lubricating the spindle 312 or the drive mechanism of a power tool, such as a reciprocating saw. The lubrication system 310 includes a storage tank or cell 314 having an interior space 316. As explained in greater detail below, the storage tank 314 can be supported in a tool housing adjacent to the drive mechanism, or alternatively, the storage tank 314 can be integrally formed with the housing adjacent to the drive mechanism.

The storage tank 314 includes an outer wall 320, which encloses a volume of a lubricant 322 and a volume of air 324. A port or drain 330 extends through the outer wall 320 of the storage tank 314 for dispensing lubricant onto the spindle 312 and/or portions of the drive mechanism. In the illustrated construction of FIG. 28 and in some aspects, the drain 330 extends downwardly through a lower portion 332 of the outer wall 320 and defines a channel 334 having an inlet 336 and an outlet 338.

Protrusions 342, 344 extend radially into the channel 334 and extend circumferentially around the inlet and outlet 336, 338, respectively. A plug or grommet 348 is supported in the channel 334 between the protrusions 342, 344 to limit flow out of the storage tank 310. In some constructions (not shown) and in some aspects, one or more fasteners can secure the plug 348 in the channel 334.

In the illustrated construction of FIG. 28 and in some aspects, the plug 348 is made from an elastomeric material, such as, for example rubber, plastic, etc. An orifice or aperture 350 extends axially through the plug 348 and communicates between the interior space 316 and the interior of the power tool.

When the power tool is relatively cool (i.e., when the motor is not operating), the pressure of the lubricant and the pressure of the air in the storage tank 314 are relatively low. Moreover, the pressure of the lubricant and the air in the-storage tank 314 is substantially equal to atmospheric pressure. As the temperature of the power tool increases (i.e., as the motor and/or drive mechanism generates heat), the pressure of the lubricant and the air in the storage tank 314 increases. The increased pressure in the storage tank 314 forces lubricant out of the interior space 316 through the aperture 350 and onto the drive mechanism and/or the spindle 312 to lubricate the power tool.

When the temperature of the power tool decreases (i.e., when the motor is not operating), the pressure of the lubricant and the air in the storage tank 314 decreases so that the pressure of the lubricant and the air in the storage tank 314 is less than or equal to atmospheric pressure, thereby allowing the aperture 350 to close and preventing unintentional dispense of lubricant. In addition, after dispensing at least some lubricant and after the temperature of the power tool decreases, the pressure of lubricant and the air in the storage tank 314 can be less than atmospheric pressure. The reduced pressure in the storage tank 314 causes air to enter the storage tank 314 through the aperture 350, effectively re-charging the lubrication system 310.

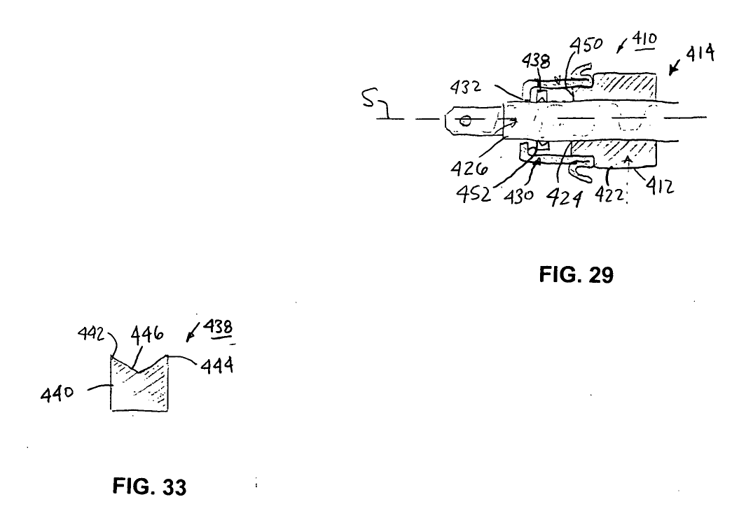

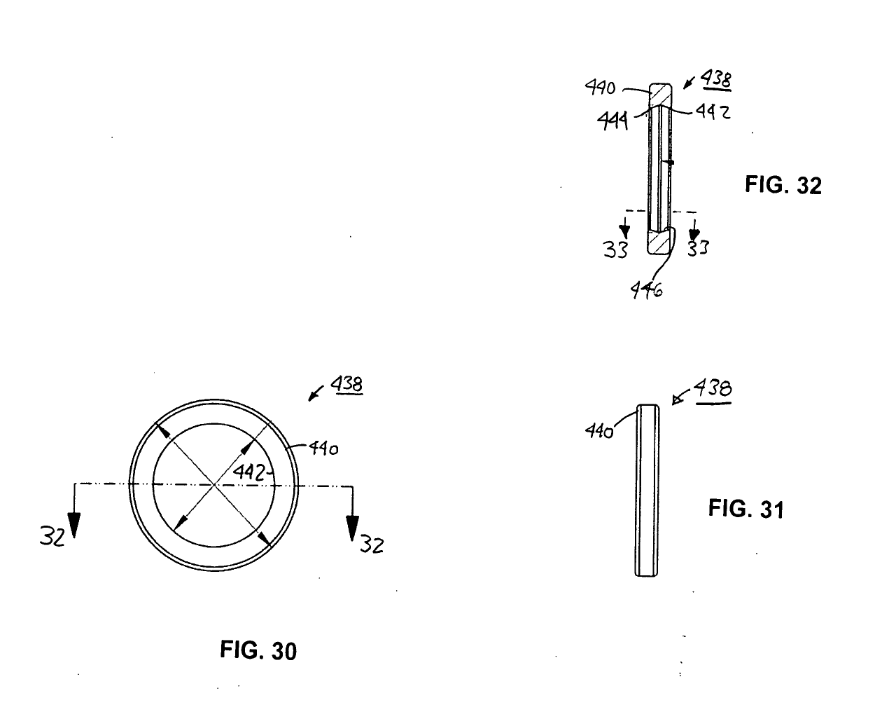

FIGS. 29-33 illustrate a sealing arrangement 410 supported on the forward portion 412 of a power tool, such as a reciprocating saw 414. In the illustrated construction of FIGS. 29-33, the forward portion 412 of the power tool includes a spindle bushing 422 having an opening 424. A spindle 426 extends outwardly from the forward portion 412 of the reciprocating saw 414 and through the opening 424 in the spindle bushing 422 for supporting a tool element, such as a saw blade.

In the illustrated construction of FIGS. 29-33 and in some aspects, a cap 430 is secured to a forward portion of the spindle bushing 422 and defines a forward opening 432. The spindle 426 extends outwardly through the forward opening 432 and is movable along a spindle axis S with respect to the spindle bushing 422. In some constructions and in some aspects, the spindle 426 is also or alternately movable along an orbital path or along a rocking path with respect to the spindle bushing 422.

In some constructions and in some aspects, the power tool includes a drive mechanism and a motor for moving the spindle 426 along the spindle axis S, or alternatively, for moving the spindle 426 along an orbital path. In these constructions and in these aspects, the drive mechanism includes a quantity of lubricant for reducing wear within the drive mechanism. In these constructions and in these aspects, the lubricant can leak out of the reciprocating saw 414 through the opening 424 in the spindle bushing 422 between the spindle bushing 422 and the spindle 426.

In the illustrated construction of FIGS. 29-33 and in some aspects, the sealing arrangement 410 includes a seal 438 supported on the spindle 426 and housed in the cap 430. The seal 438 is formed of an elastomeric material and includes a substantially circular seal body 440. In the illustrated construction of FIGS. 29-33, wiper blades 442, 444 extend radially inwardly from an inner surface 446 of the seal body 440 and are formed around the spindle 426. In other constructions and in other aspects, the seal 438 can have a substantially smooth inner surface 446.

In operation, as the spindle 426 reciprocates, the seal 438 moves axially along the spindle 426 in a direction substantially parallel to the spindle axis S. In these constructions and in these aspects, movement of the seal 438 along the spindle 426 is limited by an outer side 450 of the bushing 422 and an inner side 452 of the cap 430.

In the illustrated construction of FIGS. 29-33 and in some aspects, lubricant leaking out of the drive mechanism along the spindle 426 is trapped between the outer surface of the spindle 426 and the blades 442, 444. In addition, in some aspects and in some constructions, as the seal 438 moves along the spindle 426, the blades 442, 444 move along the outer surface of the spindle 426, wiping lubricant rearwardly along the outer surface of the spindle 426 toward the opening 424 in the spindle bushing 422. In this manner, the seal 438 prevents or limits lubricant from leaking out of the reciprocating saw 414 around the spindle 426 and forces lubricant rearwardly along the spindle 426 toward the drive mechanism.

In constructions in which the seal 438 has a substantially smooth inner surface 446, the inner surface 446 of the seal 438 moves along the outer surface of the spindle 426, wiping lubricant rearwardly along the outer surface of the spindle toward the opening 424 in the spindle bushing 422 and preventing or limiting lubricant from leaking out of the reciprocating saw 414 around the spindle 426.

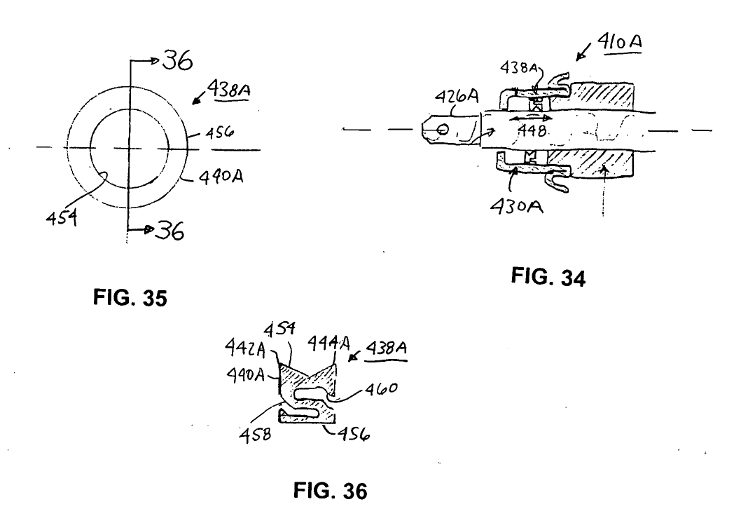

FIGS. 34-36 illustrate an alternate construction of the sealing arrangement 410. The sealing arrangement in FIGS. 34-36 is similar in many ways to the illustrated constructions of FIGS. 29-33 described above. Accordingly, with the exception of mutually inconsistent features and elements between the constructions of FIGS. 34-36 and the construction of FIGS. 29-33, reference is hereby made to the description above accompanying the construction of FIGS. 29-33 for a more complete description of the features and elements (and the alternatives to the features and elements) of the construction of FIGS. 34-36. Features and elements in the construction of FIGS. 34-36 corresponding to features and elements in the construction of FIGS. 29-33 are identified by the same reference number and the letter “A”.

In the illustrated construction of FIGS. 34-36 and in some aspects, the seal 438A is supported on the spindle 426A for movement along a travel path (represented by arrow 448) with respect to the spindle 426A. The seal 438A includes a seal body 440A having an inner surface 454 and an outer surface 456. Slots 458, 560 extend circumferentially around at least a portion of the seal body 440A between the inner and outer surfaces 454, 456. The seal body 440A also includes blades 442A, 444A, which extend radially inwardly from the inner surface 454 and are engageable with the outer surface of the spindle 426A.

In the illustrated construction of FIGS. 34-36 and in some aspects, the seal 428A is formed of an elastomeric material and is radially compressible between the cap 430A and the spindle 426A with the inner surface 454 of the seal body 440A being compressed against the outer surface of the spindle 426A and the outer surface 456 of the seal body 440A being compressed against the cap 430A.

In operation, as the spindle 426A moves along the spindle axis S, the seal 428A moves relative to the bushing 422A along the seal travel path 448. During movement of the seal 428A along the seal travel path 448, the inner surface 454 moves along the outer surface of the spindle 426A and the outer surface 456 moves along the cap 430A. In this manner, the seal 428A prevents or limits movement of lubricant out of the reciprocating saw 414A between the spindle 426A and the spindle bushing 422A. In addition, in the illustrated construction of FIGS. 34-36 and in some aspects, the blades 442A, 444A of the seal body 440A wipe lubricant rearwardly along the spindle 426A toward the opening 424A in the spindle bushing 422A and the outer surface 456 of the seal body 440A wipes lubricant rearwardly along the cap 430A toward the spindle bushing 422A. In this manner, the seal 428A prevents lubricant from leaking out of the reciprocating saw 414A and returns lubricant to a forward portion of the reciprocating saw 414A through the opening 424A in the spindle bushing 422A.

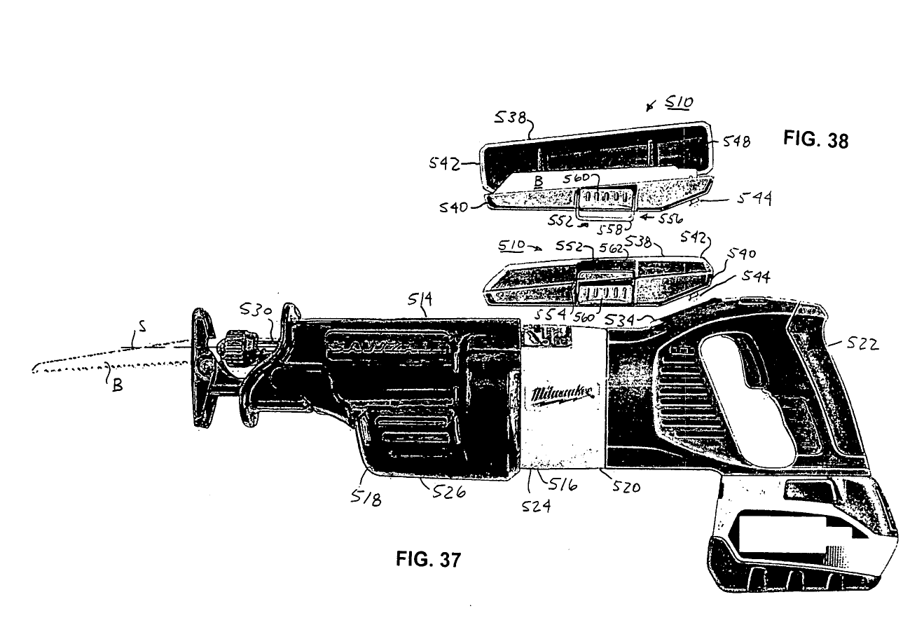

FIGS. 37-38 illustrate a storage assembly 510 removably supportable on a power tool, such as a reciprocating saw 514. In the illustrated construction of FIG. 38 and in some aspects, the power tool 514 includes a tool body 516 having a forward end 518 and a rearward end 520 and a main operator's handle or hand grip 522 connected to the rearward end 520 of the body 516. The body 516 is provided by a housing assembly having a motor housing 524 and a gear case 526. In the motor housing 524, the body 516 houses a motor (not shown but similar to that shown in FIG. 8), and, in the gear case 526, the body 516 houses a drive mechanism (not shown but similar to that shown in FIG. 8) drivingly connected to the motor.

The motor and the drive mechanism are operable to reciprocate a spindle 530 generally along a spindle axis S. In the illustrated construction of FIG. 37, the spindle 530 is supported by the forward end 518 of the body 516 for reciprocating motion and may be supported for rocking motion or orbital motion relative to the body 526. As shown in FIG. 37, the spindle 530 is adapted to support a saw blade B for cutting a workpiece (not shown but similar to that shown in FIG. 10) in a cutting plane defined by the saw blade B.

Rails 534 extend along an upper surface of the reciprocating saw 514 and define a slot (not shown). In the illustrated construction of FIG. 37, the rails 534 extend along an upper surface of the rearward end 520 of the tool body 516 and along an upper surface of the grip 522.

As shown in FIGS. 37-38, the storage assembly 510 includes a body 538 having a lower portion 540 and an upper portion 542 hingedly connected to the lower portion 540 for movement with respect to the lower portion 540 between a first or opened position (shown in FIG. 38) and a second or closed position (shown in FIG. 37). A protrusion 544 extends outwardly from the lower portion 542 and is engageable in the slot between the rails 534 to secure the storage assembly 510 to the reciprocating saw 514.

The lower and upper portions 540, 542 substantially enclose a storage space 548 for receiving tool elements. In the illustrated construction of FIGS. 37-38 and in some aspects, the storage assembly 510 is adapted to receive saw blades B. In other constructions and in other aspects, the storage assembly 510, can be adapted to receive other tool elements, such as, for example drill bits.

The storage assembly 510 can also include a locking assembly 552 for securing the upper portion 542 of the body 538 in the closed position and for maintaining tool elements in the storage space 548. In the illustrated construction of FIGS. 37-38 and in some aspects, the locking assembly 552 includes a protrusion 554 extending outwardly from the upper portion 542 of the body 538 and a latching assembly 556 secured to the lower portion 540 of the body 538. The latching assembly 556 includes a locking element 558 and a handle 560. To secure the locking assembly 552 in a locked position (shown in FIG. 37), an operator places the locking element 558 over the protrusion 554 and moves the handle 560 downwardly to engage the locking element 558 in a groove 562 defined between the protrusion 554 and the upper portion 542 of the body 538. To move the locking assembly 552 toward an unlocked position (shown in FIG. 38), an operator moves the handle 560 upwardly and moves the locking element 558 out of the groove 562.

In the illustrated construction of FIGS. 37-38 and in some aspects, the storage assembly 510 is formed of a molded plastic material to resist bending and to protect tool elements housed in the storage assembly 510 from damage. In other constructions and in other aspects, the storage assembly 510 can be formed of other materials, including soft and bendable materials.

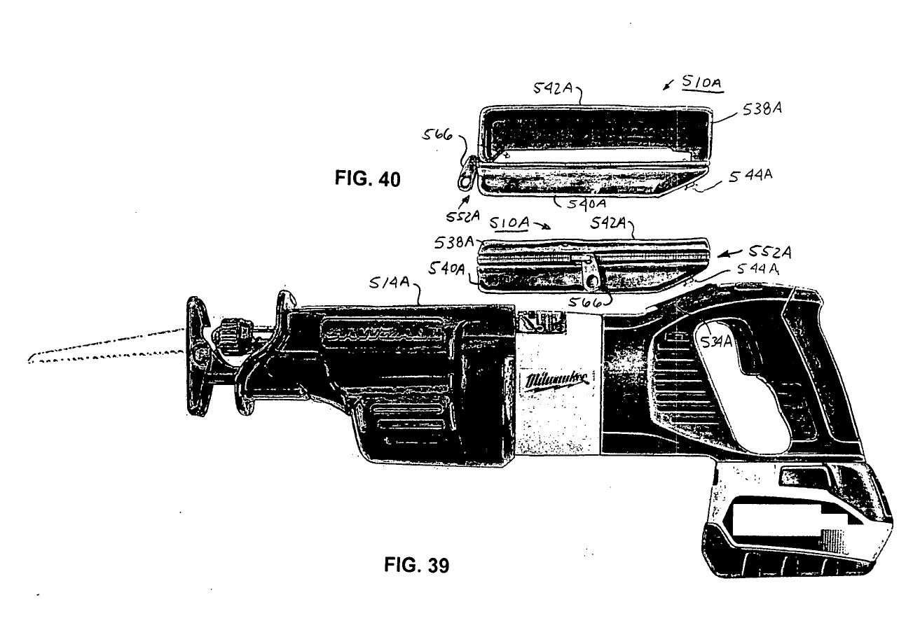

FIGS. 39-40 illustrate an alternate construction of the storage assembly 510A. The storage assembly in FIGS. 39-40 is similar in many ways to the illustrated constructions of FIGS. 37-38 described above. Accordingly, with the exception of mutually inconsistent features and elements between the construction of FIGS. 39-40 and the construction of FIGS. 37-38, reference is hereby made to the description above accompanying the construction of FIGS. 37-38 for a more complete description of the features and elements (and the alternatives to the features and elements) of the construction of FIGS. 39-40. Features and elements in the construction of FIGS. 39-40 corresponding to features and elements in the construction of FIGS. 37-38 are identified by the same reference number and the letter “A”.

In the illustrated construction of FIGS. 39-40 and in some aspects, the storage assembly 510A includes a body 538A formed of a soft material, such as, for example, nylon. The body 538A includes an outwardly extending protrusion 544A. The protrusion 544A is securable in a slot defined between rails 534A, which are located on an upper surface of a power tool, such as a reciprocating saw 514A.

The storage assembly 510A can also include a locking assembly 552A for securing the upper portion 542A in the closed position. In the illustrated construction of FIGS. 39-40 and in some aspects, the locking assembly 552A includes a zipper 566 located between the lower and upper portions 540A, 542A of the body 538A. In other constructions and in other aspects, other fasteners can be employed to secure the lower and upper portions 540A, 542A as just described, such as pins, clips, clamps, inter-engaging elements, and any combination of such fasteners.

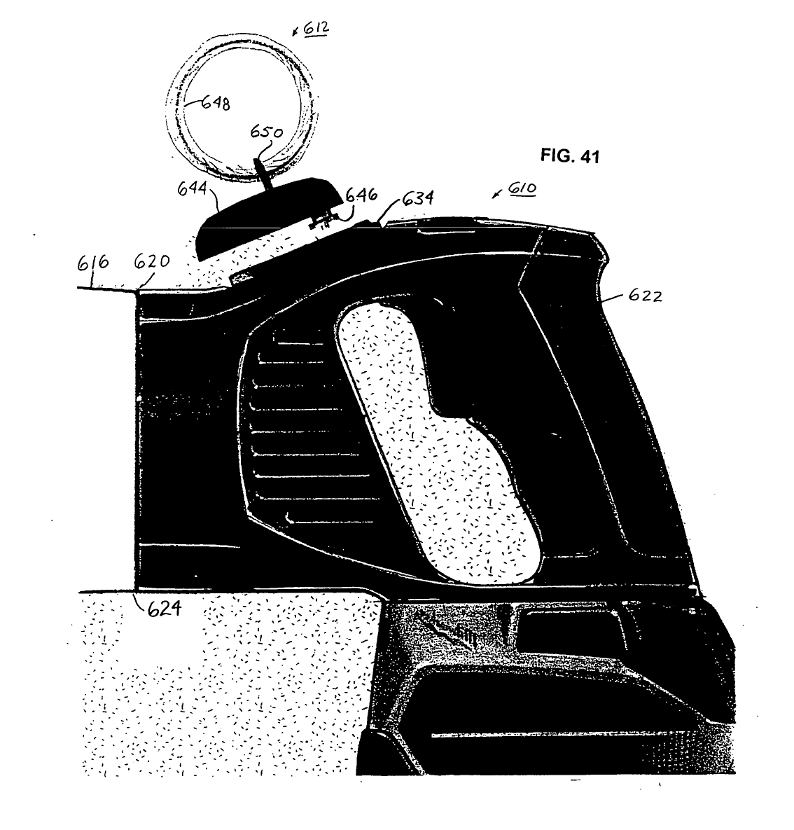

FIG. 41 illustrates a power tool, such as a reciprocating saw 610, and a support member or a mounting and/or carrying hook 612. In the illustrated construction of FIG. 41 and in some aspects, the reciprocating saw 610 includes a tool body 616 having a rearward end 620 and a main operator's handle or hand grip 622 connected to the rearward end 620 of the body 616. The body 616 is provided by a housing assembly having a motor housing 624 and a gear case (not shown but similar to that shown in FIG. 37). In the motor housing 624, the body 616 houses a motor (not shown but similar to that shown in FIG. 8), and, in the gear case, the body 616 houses a drive mechanism (not shown but similar to that shown in FIG. 8) drivingly connected to the motor.

Rails 634 extend along an upper surface of the reciprocating saw 614 and define a slot (not shown). In the illustrated construction of FIG. 41, the rails 634 extend along an upper surface of the rearward end 620 of the tool body 616 and along an upper surface of the grip 622.

As shown in FIG. 41, the mounting and carrying hook 612 includes a mounting body 644 and a protrusion 646 extending outwardly and downwardly from the mounting body 644. The protrusion 646 is slidingly engageable in the slot between the rails 634 to secure the mounting and carrying hook 612 to the reciprocating saw 610. In the illustrated construction of FIG. 41 and in some aspects, the mounting and carrying hook 612 also includes a ring 648 pivotably secured to an upper portion 650 of the mounting body 644.

In operation, an operator engages the protrusion 646 in the slot defined by the rails 634 to secure the mounting and carrying hook 612 to the reciprocating saw 610. The operator can then secure the ring 648 to a tool belt to simplify transportation of the reciprocating saw 610. Alternatively, an operator can secure the mounting and carrying hook 612 to the reciprocating saw 610 and can secure the ring 648 to a wall peg or hook to hang the reciprocating saw 610 on a workshop wall. In addition, an operator can secure the mounting and carrying hook 612 to the reciprocating saw 610 and can secure a rope to the ring 648 for lifting the reciprocating saw 610 to an elevated position, such as an upper portion of scaffolding or a ladder. The operator can also remove the mounting and carrying hook 612 as shown in FIG. 41.

The arrangement for connecting and supporting the storage assembly 510, 510A and/or the hook 612 may be similar to that shown and described in U.S. patent application Ser. No. 10/389,070, filed Mar. 14, 2003, the entire contents of which are hereby incorporated by reference.

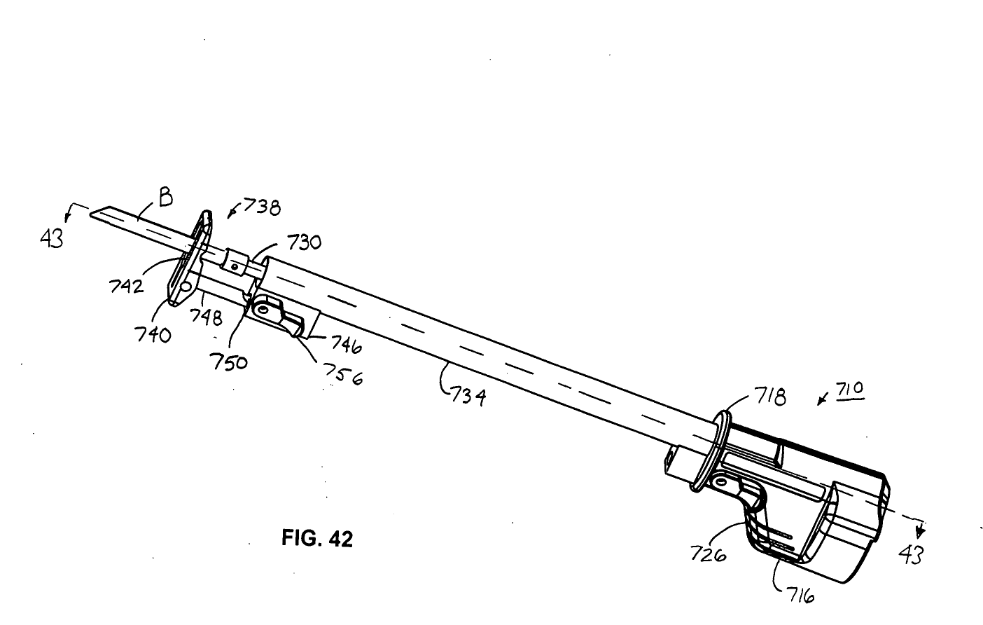

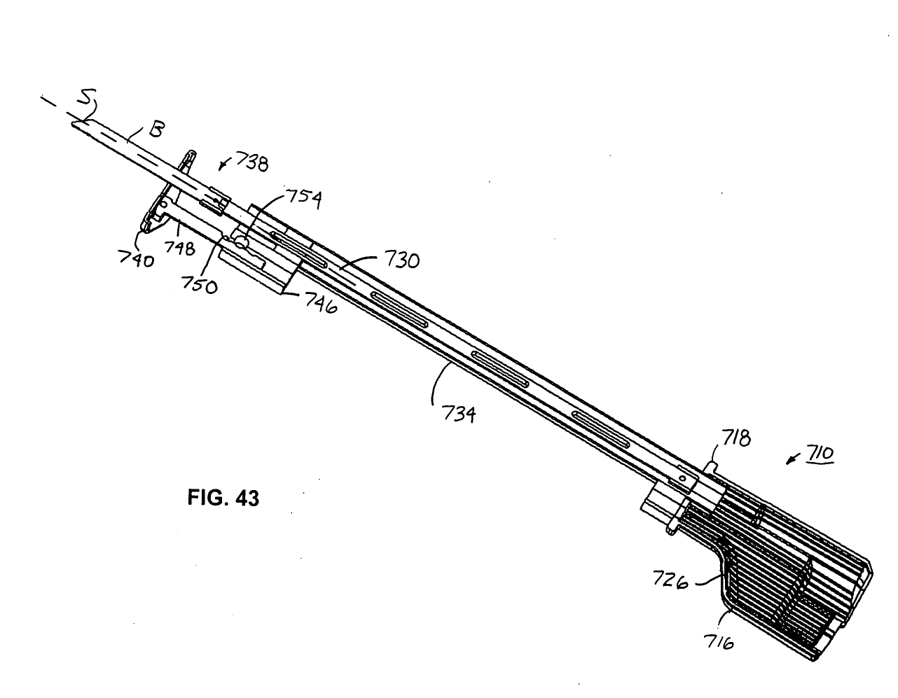

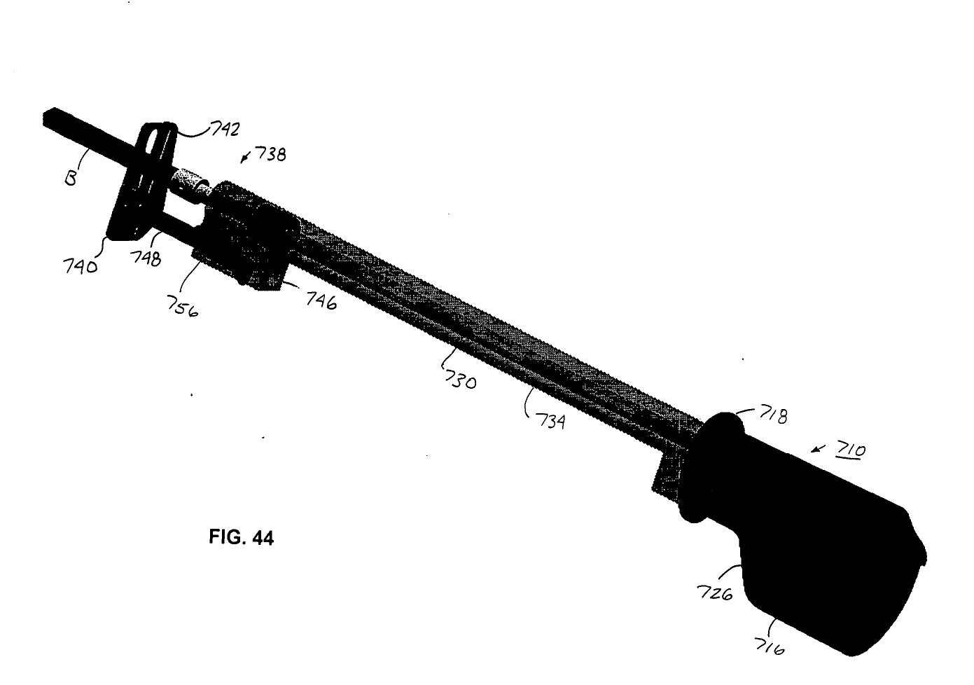

FIGS. 42-44 illustrate a power tool, such as a reciprocating saw 710, including a tool body 716 having a forward end 718. The body 716 is provided by a housing assembly having a motor housing (not shown but similar to that shown in FIG. 37) and a gear case 726. In the motor housing, the body 716 houses a motor (not shown but similar to that shown in FIG. 8), and, in the gear case 726, the body 716 houses a drive mechanism (not shown but similar to that shown in FIG. 8) drivingly connected to the motor.

The reciprocating saw 710 also includes an extension assembly. The extension assembly may be removably connected to the housing assembly. The motor and the drive mechanism are operable to reciprocate an extended spindle 730 generally along a spindle axis S. In the illustrated construction of FIGS. 42-44, the extended spindle 730 is supported by the forward end 718 of the body 716 for reciprocating motion (and may be supported for rocking motion or orbital motion) relative to the body 716. As shown in FIGS. 42-44, the extended spindle 730 is adapted to support a saw blade B for cutting a workpiece (not shown but similar to that shown in FIG. 10) in a cutting plane defined by the saw blade B. At a rearward end, the extended spindle 730 is drivingly connected to a spindle (not shown but similar to the spindle 28) which is driven by the drive mechanism. In some operations, the extension assembly may be removed from the reciprocating saw 710, and the saw blade B may be supported on the end of the spindle (as shown in FIG. 10).

The reciprocating saw 710 also includes an extension housing 734 that is supported in the body 716. The extension housing 734 is generally cylindrical and has a hollow inner portion for receiving the extended spindle 730. The extended spindle 730 is supported by the extension housing 734 for reciprocating movement along the longitudinal axis of the extension housing 734.

In the illustrated construction of FIGS. 42-44 and in some aspects, the extension housing 734 is elongated and extends outwardly from the forward end 718 of the body 716. In this manner, the forward end of the extended spindle 730 and the saw blade B supported by the forward end of the extended spindle 730 are spaced a distance from the forward end 718 of the tool body 716. In these constructions and in these aspects, an operator can position the forward end of the extended spindle 730 and the saw blade B in hard-to-reach areas. Moreover, an operator can insert the forward end of the extended spindle 730 and the saw blade B supported by the forward end of the extended spindle 730 between two or more obstructions to perform cutting operations in relatively confined spaces. Alternatively or in addition, an operator can position the forward end of the extended spindle 730 and the saw blade B above his or her head for performing overhead cutting operations, thereby removing the need for the operator to climb a ladder or stand on a stool. In other operations, the extension assembly may be removed from the reciprocating saw 710, and the reciprocating saw 710 may be operated in a normal condition with the saw blade B supported by the spindle.

In the illustrated construction of FIGS. 42-44 and in some aspects, the reciprocating saw 710 also includes an adjustable shoe assembly 738 connected to a forward end of the extension housing 734. In some constructions and in some aspects, the reciprocating saw 710 may include an adjustable shoe assembly 738, such as the adjustable shoe support described in U.S. Pat. No. 6,249,979. As shown in FIGS. 42-44, the adjustable show assembly 738 includes a shoe plate 740 having a surface for engaging a workpiece. The shoe plate 740 defines an aperture 742 through which the saw blade B is extendable. The aperture 742 can also be dimensioned to accommodate an orbital path of the saw blade B.

The adjustable shoe support assembly 738 also includes a shoe support block 746 secured to a forward portion of the extension housing 734. A shoe support member 748 is pivotably connected to the shoe plate 740 and is movably supported in the shoe support block 746 to adjust the position of the shoe plate 740 relative to the shoe support block 746.

The shoe support member 748 includes a plurality of notches 750 formed along the length of the shoe support member 748. The adjustable shoe assembly 738 also includes a locking member 754 pivotably supported by the shoe support block 746. The locking member 754 is generally cylindrical but includes an axially extending flat surface (not shown). A release lever 756 is connected to an end of the locking member 754 so that pivotal movement of the lever 756 causes pivotal movement of the locking member 754 between a first or locking position, in which a rounded portion of the locking member 754 engages one of the notches 750 formed along the length of the shoe support member 748, and a second or releasing position, in which the flat surface of the locking member 754 is generally aligned with the notches 750 formed along the length of the shoe support member 746.

In this manner, an operator can pivot the release lever 756 toward the locking position to prevent the shoe support member 748 from moving with respect to the shoe support block 746. Alternatively, the operator can pivot the release lever 756 toward the releasing position so that the locking member 754 does not engage the notches 750 formed along the length of the shoe support member 748 and so that the shoe support member 746 is axially movable with respect to the shoe support block 746.

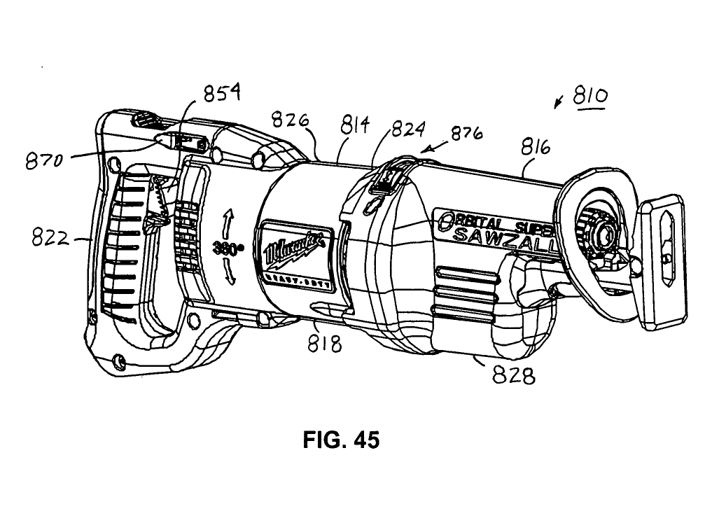

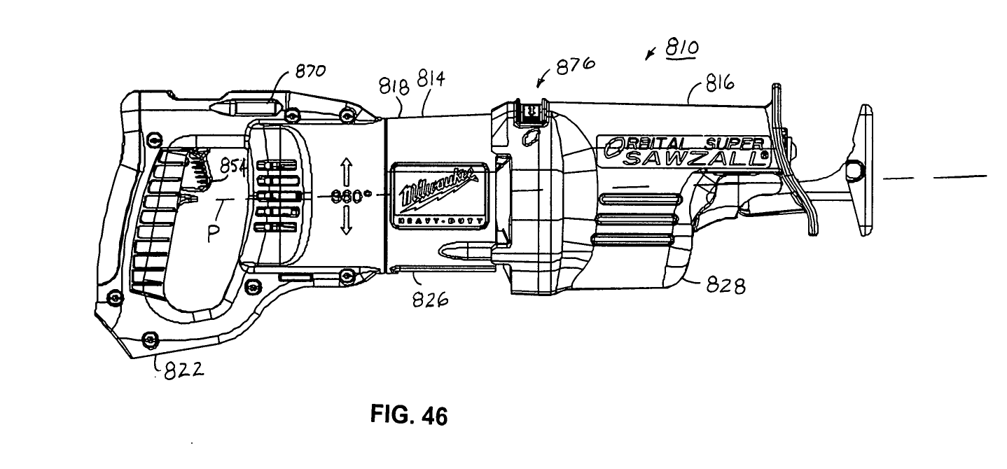

FIGS. 45-47 illustrate a power tool, such as a reciprocating saw 810, including a body 814 having a forward end 816 and a rearward end 818 and a main operator's handle or hand grip 822 connected to the rearward end 818 of the body 814. In some constructions and in some aspects, the hand grip 822 may be pivotably connected to the rearward end 818 of the body, such as the reciprocating saw shown and described in U.S. patent application Ser. No. 10/453,162, filed Jun. 3, 2003, and U.S. patent application Ser. No. 10/011,251, filed Dec. 3, 2001, the entire contents of which are hereby incorporated by reference.

In the illustrated construction of FIGS. 45-47 and in some aspects, the body 814 defines a pivot axis P, and the grip 822 is pivotable about the pivot axis P between a plurality of positions. FIGS. 45-47 illustrate a neutral or normal operating position for the reciprocating saw 810. The hand grip 822 can also be pivoted in a first (i.e., clockwise) direction and in a second (i.e., counterclockwise) direction about the pivot axis P and relative to the body 814 toward alternative positions.

As shown in FIGS. 45-47, the body 814 is provided by a housing assembly including a motor housing 826 and a gear case 828. In the motor housing 826, the body 814 houses a motor 830, and, in the gear case 828, the body 814 houses a drive mechanism 832, such as a wobble plate drive, drivingly connected to the motor 830. The motor 830 and the drive mechanism 832 are operable to reciprocate a spindle 836 along a spindle axis S.

In the illustrated construction of FIGS. 45-47 and in some aspects, the spindle 836 is supported by the forward end of the body 814 for reciprocating motion and may also be supported for rocking motion or orbital motion relative to the body 814. The spindle 836 is adapted to support a saw blade (not shown but similar to that shown in FIG. 10) for cutting a workpiece in a cutting plane defined by the saw blade.

In the illustrated construction of FIGS. 45-47 and in some aspects, a groove 840 extends circumferentially around the exterior surface of the rearward end 818 of the body 814. A ring 842 is held in the groove 840, and a sleeve 844 extends circumferentially around the ring 842 between the rearward end 818 of the body 814 and the grip 822. To facilitate rotation of the grip 822 relative to the body 814, one or all of the ring 842, the sleeve 844 and the grip 822 have relatively smooth, low-friction engaging surfaces and are sized to rotate freely about the pivot axis P with respect to one another and with respect to the rearward end 818 of the body 814.

The motor 830 is an electric motor and is connectable to a power source, such as, for example, to a separate AC or DC power source by a plug and a power cord (not shown) or to a battery (not shown) supported on the grip 822. An electrical circuit is operable to connect the motor 830 to the power source and includes a switch assembly 850 supported on the hand grip 22A. The switch assembly 850 is operable to selectively connect the motor 830 to the power source.

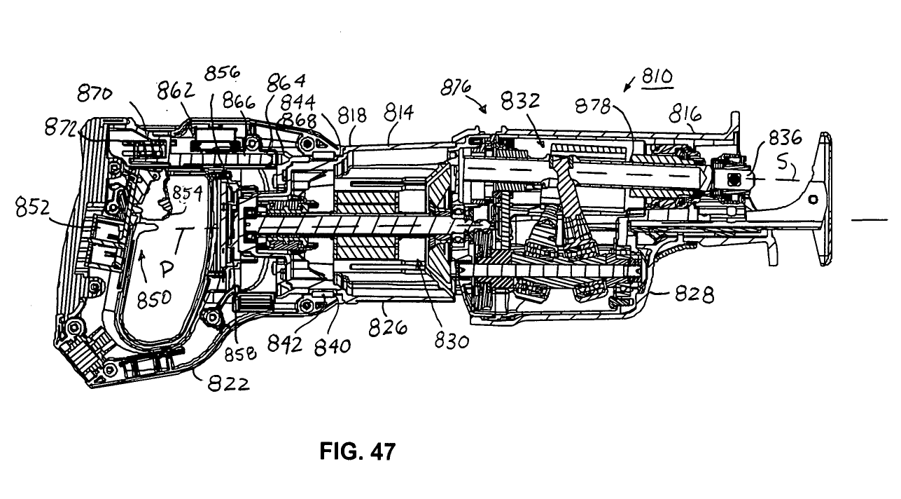

As shown in FIG. 47, the switch assembly 850 includes an on/off switch 852 and a trigger 854. In some constructions and in some aspects, at least a portion of the switch assembly 850 is supported on the hand grip 822 for pivoting movement with the hand grip 822 relative to the rearward end 818 of the body 814. To accommodate pivoting movement of the switch assembly 850 with the hand grip 822 about the pivot axis P and relative to the motor 830 and the drive mechanism 832, a fixed electrical connector 856 is provided on one of the grip 822 and the body 814 and is connected to the associated one of the switch assembly 850 and the motor 830. A movable electrical connector 858 may be provided on the other of the grip 822 and the body 814 and is connected to the associated one of the switch assembly 850 and the motor 830. The movable electrical connector 858 moves along and maintains electrical connection with the fixed electrical connector 856 during movement of the switch assembly 850 with the hand grip 822 relative to the motor 830 and the drive mechanism 832 to maintain the electrical connection between the switch assembly 850 and the motor 830.

In other constructions and in other aspects (not shown), other connecting structures, such as those described in U.S. patent application Ser. No. 10/453,162 and U.S. patent application Ser. No. 10/011,251 can also or alternately be used.

As shown in FIGS. 45-47, the reciprocating saw 810 can also include a locking assembly 862 for locking the grip 822 in a pivoted position relative to the body 814. In the illustrated constructions and in some aspects, the rearward end 818 of the housing 814 defines a number of recesses 864 circumferentially spaced around the pivot axis P. The locking assembly 862 includes a locking pin 866 having a tapered locking projection 868 and an actuator 870 operable to move the locking pin 866 axially between a locking position, in which the locking pin 866 is at least partially received in one of the recesses 864, and an unlocking position, in which the locking pin 866 is withdrawn from the recesses 864.

In the illustrated construction and in some aspects, the locking assembly 862 also includes a biasing member, such as a spring 872, which biases the actuator 870 and the locking pin 866 toward the locked position.

To move the grip 822 relative to the body 814, an operator moves the actuator 870 and the locking pin 866 rearwardly toward the unlocking position and pivots the hand grip 822 about the pivot axis P with respect to the rearward end 818 of the body 814 toward a desired operating position. The operator then moves the actuator 870 and the locking pin 866 forwardly toward the locking position to prevent unwanted movement of the hand grip 822 about the pivot axis P with respect to the rearward end 818 of the body 814.

In the illustrated construction of FIG. 47 and in some aspects, the reciprocating saw 810 also includes an orbital adjustment assembly 876 for adjusting the orbital path of a saw blade supported on a forward end of the spindle 836, such as the orbital adjustment assembly described in U.S. Pat. No. 6,249,979. In these constructions and in these aspects, the reciprocating saw 810 includes a tube chassis 878, which is generally cylindrical and has a hollow inner portion for receiving the spindle 836. In operation, the orbital adjustment assembly 876 is operable to pivot at least a portion of the tube chassis 878 with respect to the tool body 814 so that the forward end of the spindle 836 and the saw blade move along an orbital path, or alternatively, so that the forward end of the spindle 836 and the saw blade move along a substantially linear path.

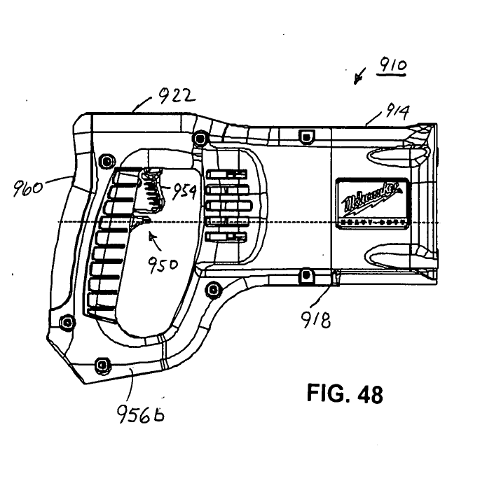

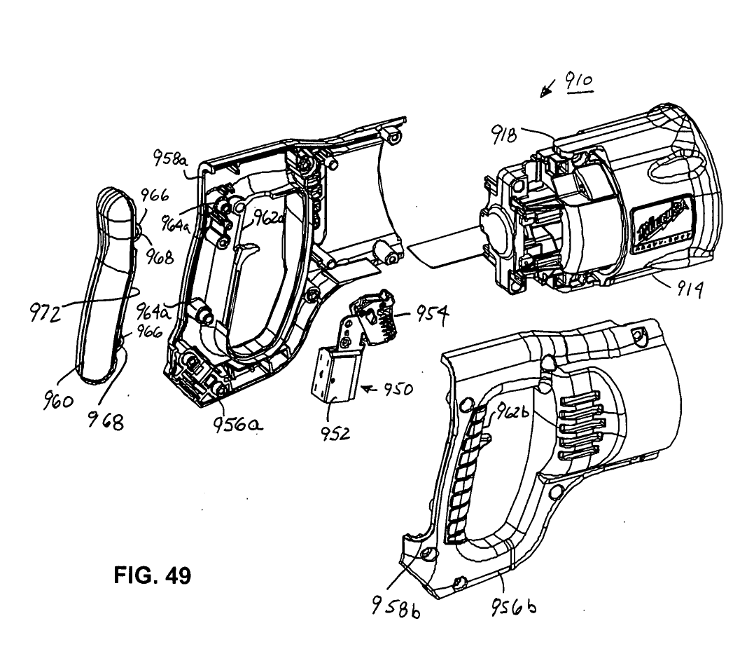

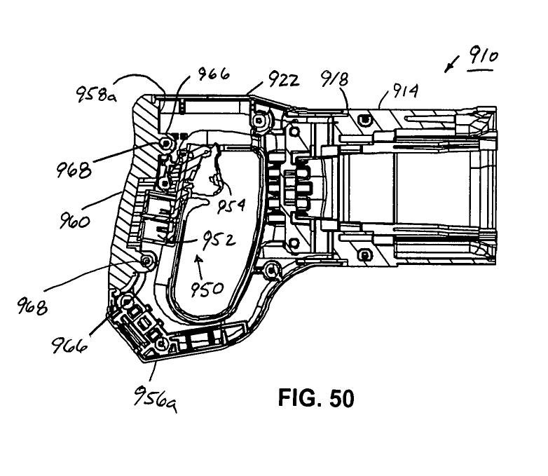

FIGS. 48-50 illustrate a portion of a power tool, such as a reciprocating saw 910, including a body 914 having a rearward end 918 and a main operator's handle or hand grip 922 connected to the rearward end 918 of the body 914. The body 914 houses a motor (not shown but similar to that shown in FIG. 8) and a drive mechanism (not shown but similar to that shown in FIG. 8) drivingly connected to the motor.

The motor is an electric motor and is connectable to a power source, such as, for example, to a separate AC or DC power source by a plug and a power cord (not shown) or to a battery (not shown) supported on the grip 922. An electrical circuit is operable to connect the motor to the power source and includes a switch assembly 950 supported on the hand grip 922. As shown in FIG. 48-50, the switch assembly 950 includes an on/off switch 952 and a trigger 954 and is operable to selectively connect the motor to the power source.

In the illustrated construction of FIGS. 48-50 and in some aspects, the grip 922 is a D-shaped handle adapted to be gripped by one of an operator's hands. The hand grip 922 is formed of first and second handle halves 956a, 956b. The first and second handle halves 956a, 956b are mirror images and include rearward openings 958a, 958b for receiving a cushion grip 960 and forward openings 962a, 962b for receiving the switch assembly 950. The handles 956a, 956b also include laterally extending posts 964a (the laterally extending posts of the second handle half 956b are not show but are substantially similar to the laterally extending post 964a), which are interengageable to connect the handles 956a, 956b.

During assembly, the cushion grip 960 is positioned in one of the handle halves (e.g., the first handle half 956a) so that at least a portion of the cushion grip 960 extends outwardly through the respective rearward opening (e.g., the rearward opening 958a of the first handle half 956a). In the illustrated construction of FIGS. 48-50 and in some aspects, the cushion grip 960 includes tabs 966 having openings 968. In these constructions and in these aspects, the cushion grip 960 is positioned in one of the handle halves (e.g., handle half 956a) so that the tabs 966 are positioned over the laterally extending posts (e.g., laterally extending posts 964a) and so that the laterally extending posts extend through the openings 968. The switch assembly 950 is then positioned in one of the handle halves (e.g., first handle half 956a) so that at least a portion of the trigger 954 extends outwardly through the forward opening (e.g., the forward 962a of the first handle half 956a).

The handle halves 956a, 956b are then aligned and pressed together so that the laterally extending posts 964a of the first handle half 956a engage the laterally extending posts of the second handle half 956b. As the handle halves 956a, 956b are pressed together, the cushion grip 960 is secured between the handle halves 956a, 956b. In the illustrated construction and in some aspects, the cushion grip 960 includes an outwardly extending lip 972. In these constructions and in these aspects, during assembly, the outwardly extending lip 972 is compressed between the handle halves 956a, 956b and the switch assembly 950, forming a seal around the rearward openings 958a, 958b and inhibiting the entry of debris between the cushion grip 960 and the handle halves 956a, 956b. Fasteners (not shown) then secure the first and second handle halves 956a, 956b together. Any conventional fastener can be employed to secure the first and second handle halves 956a, 956b as just described, such as screws, nails, rivets, pins, posts, clips, clamps, inter-engaging elements, and any combination of such fasteners.

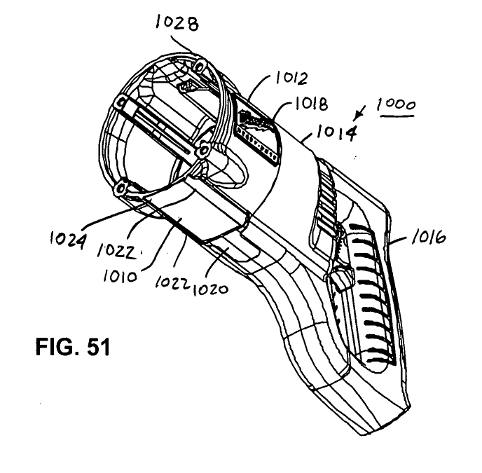

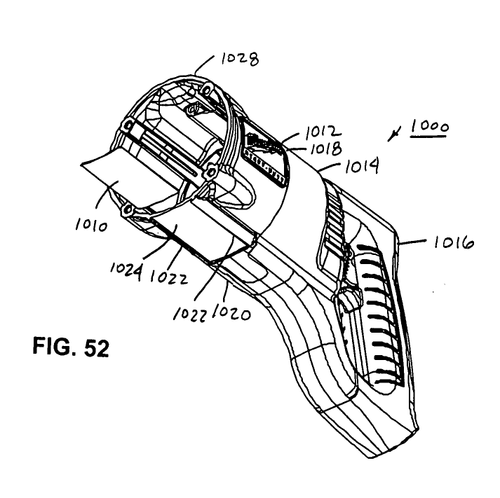

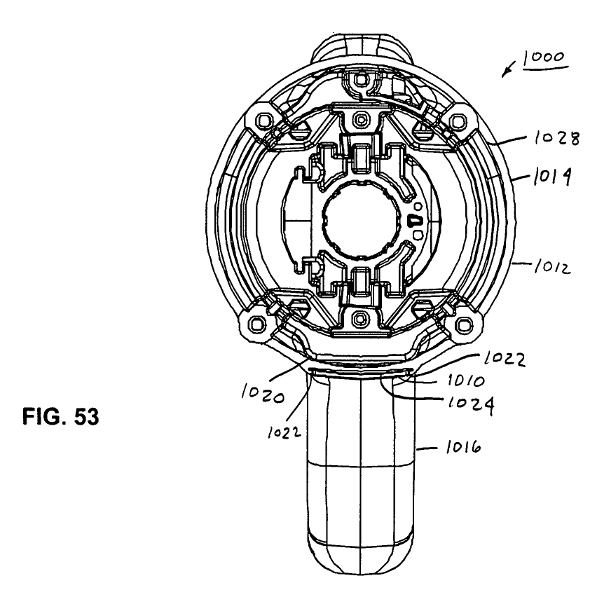

FIGS. 51-53 illustrate a portion of a power tool, such as a reciprocating saw 1000, including an information or identification plate 1010. The reciprocating saw 1000 includes a housing assembly 1012 having a body 1014 and a main operator's handle portion or hand grip 1016 connected to the a rearward portion 1018 of the body 1014. Although not shown, the identification plate 1010 can include text, symbols or operating instructions imprinted on or engraved in an outer surface.

An underside 1020 of the body 1014 includes rails 1022 which define a slot 1024 for receiving the identification plate 1010. During assembly, the identification plate 1010 is inserted in the slot 1024 between the rails 1022. A forward end 1028 of the body 1014 is then connected to a gear case (not shown but substantially similar to the gear case of FIG. 37). The identification plate 1010 is then secured in the slot 1024 between the rails 1022, the forward end 1028 of the body 1014 and a rearward end of the gear case. Any conventional fastener can be employed to secure the forward end 1028 of the body 1014 and to the rearward end of the gear case as just described, such as screws, nails, rivets, pins, posts, clips, clamps, inter-engaging elements, and any combination of such fasteners.

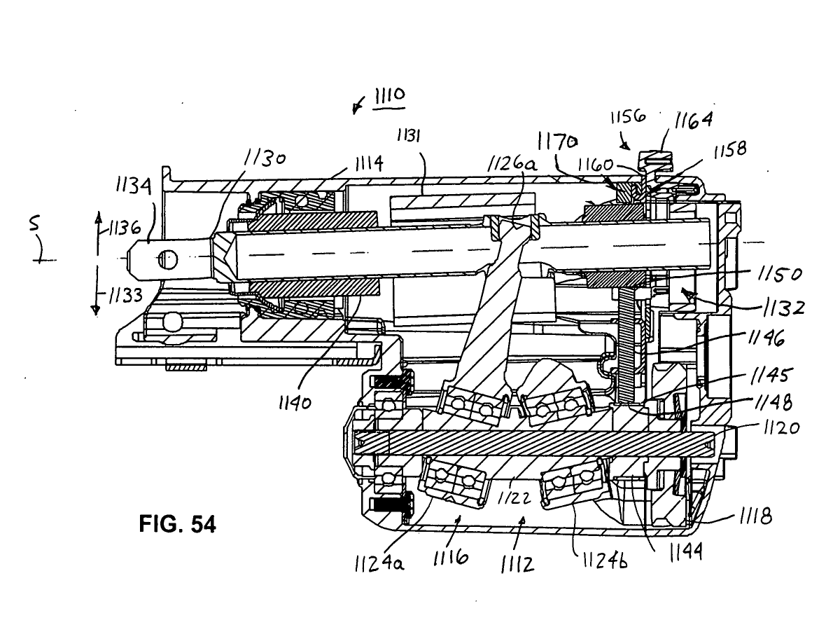

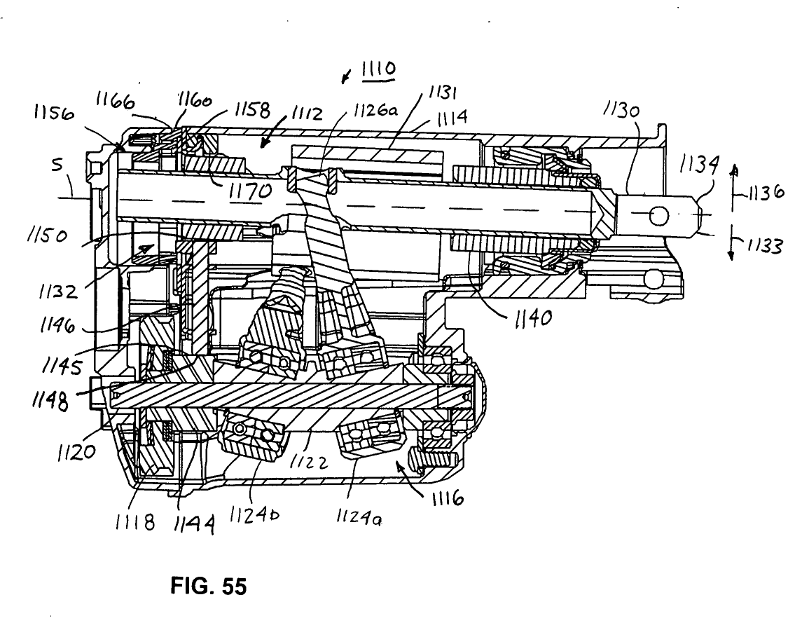

FIGS. 54-55 illustrate a portion of a power tool, such as a reciprocating saw 1110 including a drive assembly 1112 and a body 1114 housing the drive assembly 1112. In the illustrated construction of FIGS. 54-55 and in some aspects, the drive mechanism 1122 includes a wobble plate drive assembly 1116 such as the wobble plate drive assembly described in U.S. Pat. No. 6,249,979.

In the illustrated construction of FIGS. 54-55, the wobble plate drive assembly includes a gear 1118 mounted on a gear shaft 1120. A wobble shaft 1122 is mounted on the gear shaft 1120 and supports first and second drive arms or wobble plates 1124a, 1124b. A ball-shaped end 1126a of the first wobble plate 1124a is connected to a spindle 1130 and is operable to reciprocate the spindle 1130 generally along a spindle axis S. A ball-shaped end (not shown but similar to the ball-shaped end 1126a of the first wobble plate 1124a) of the second wobble plate 1124b is connected to a counterweight 1131 and is operable to reciprocate the counterweight 1131 generally along the spindle axis S in an opposite direction to the spindle 1130 to counteract the forces created by movement of the spindle 1130.

The drive assembly 1122 also includes an orbital drive assembly 1132 for driving the spindle 1130 in an orbital motion (e.g., reciprocating and pivoting motion). The orbital motion is characterized by a downward (i.e., in the cutting direction 1133) motion of a forward end 1134 of the spindle 1130 and a saw blade (not shown but similar to that shown in FIG. 10) supported by the spindle 1130 as the forward end 1134 of the spindle 1130 is being retracted rearwardly toward the body 1114 on the cutting stroke, and a corresponding upward (i.e., in the non-cutting direction 1136) motion of the forward end 1134 of the spindle 1130 and the saw blade supported by the spindle 1130 as the forward end 1134 of the spindle 1130 is being extended forwardly away from the body 1114 on the return stroke. This results in a circuitous or orbital path of the forward end 1134 of the spindle 1130 and the saw blade supported by the spindle 1130.

In the illustrated construction of FIGS. 54-55, the drive assembly 1112 includes a tube chassis 1140 that is supported in the body 1114 for pivotal movement relative to the body 1114. The tube chassis 1140 has a generally cylindrical cross-sectional shape and has a hollow interior portion for supporting the spindle 1130. As shown in FIGS. 54-55, the drive assembly 1112 also includes a cam member 1144 supported on the gear shaft 1120 for rotation with the gear shaft 1120 about the axis of the gear shaft 1120. The cam member 1144 has an outer surface 1145, which is eccentric with respect to the axis of the gear shaft 1120 so that the outer surface of the cam member 1140 rotates eccentrically about the axis of the gear shaft 1120.

A cam follower 1146 is supported in the body 1114 for movement relative to the body 1114 along the cam follower axis and includes a lower portion 1148 that is selectively engageable with the eccentric outer surface 1145 of the cam member 1144. In the illustrated construction of FIGS. 54-55, an upper portion 1150 of the cam follower 1146 engages a rearward portion of the tube chassis 1140 so that when the cam follower 1146 reciprocates along the cam follower axis, the cam follower 1146 causes a rearward portion of the tube chassis 1140 to pivot relative to the body 1114. In addition, the spindle 1130, which is supported in the tube chassis 1140, pivots relative to the body 1114 with the tube chassis 1140.

As shown in FIGS. 54-55, the drive assembly 1112 also includes an orbital adjustment assembly 1156 for adjusting the orbital path of the spindle 1130. The orbital adjustment assembly 1156 includes an adjustment member 1158 pivotably supported in the body 1114 and including a number of cam surfaces (not shown) adjacent to the upper portion 1150 of the cam follower 1146 so that the upper portion 1150 of the cam follower 1146 is selectively engageable with each of the cam surfaces of the adjustment member 1158. A release member 1160 is positioned around a rearward end of the tube chassis 1140 for rotating the adjustment member 1158 relative to the cam follower 1146 and includes a handle portion 1164, which extends outwardly through an opening 1166 in the body 1114.

In the illustrated construction of FIGS. 54-55 and in some aspects, the reciprocating saw 1110 also includes a bumper or cushion 1170 secured to an upper portion of the body 1114 and positioned adjacent to the tube chassis 1140. In these constructions and in these aspects, the bumper 1170 is formed of an elastomeric material and is deformable. In this manner, the bumper 1170 is operable to limit upward movement of the tube chassis 1140 and is operable to absorb impacts between the rearward end of the tube chassis 1140 and the body 1114. Alternatively or in addition, the cushion 1170 can absorb impacts transmitted through the spindle 1130 and the tube chassis 1140 and can prevent or limit the transmission of these impact forces through the drive assembly 1112.

In operation, an operator pivots the handle portion 1164 of the release member 1160 with respect to the body 1114, causing the adjustment member 1158 to rotate relative to the cam follower 1146. The adjustment member 1158 then moves the cam follower 1146 upwardly or downwardly along the cam follower axis to adjust the orbital motion of spindle 1130.

Although particular constructions of the present invention have been shown and described, other alternative constructions will be apparent to those skilled in the art and are within the intended scope of the present invention.

What is claimed is:

1. A combination comprising:
a reciprocating saw including a reciprocatable spindle for supporting a saw blade for reciprocating sawing movement and a body housing a motor and a drive mechanism driven by the motor, the drive mechanism selectively driving the spindle, the body having a forward end supporting the spindle; and
a battery connectable to the body and having a forward-most point and a lower surface spaced rearwardly from the forward-most point.

2. The combination of claim 1, wherein the battery includes a forward surface having an exterior side, and wherein the lower surface has an exterior side, the exterior side of the forward surface being oriented at an obtuse angle with respect to the exterior side of the lower surface.

3. The combination of claim 1, further comprising a shoe support connected to the forward end of the body, and wherein, during sawing of a work piece, a forward-most portion of the saw blade and a lower-most portion of the shoe support are positionable against the work piece and the battery is spaced a distance from the work piece.

4. The combination of claim 3, wherein the battery includes a forward surface having an exterior side, and wherein, during sawing of the work piece, at least a portion of the forward surface is substantially parallel to at least a portion of the work piece.

5. The combination of claim 1, wherein, during plunge-cutting, the battery is maintained a distance from a work piece.

6. The combination of claim 1, wherein a forward surface of the battery is non-perpendicular to the lower surface of the battery.

7. The combination of claim 1, wherein the battery includes a first forward surface and a second forward surface, each of the first forward surface and the second forward surface having an exterior side, the exterior side of the second forward surface being oriented at an obtuse angle with respect to the exterior side of the first forward surface.

8. A combination comprising:
a reciprocating saw including a reciprocatable spindle for supporting a saw blade for reciprocating sawing movement and a body housing a motor and a drive mechanism driven by the motor, the drive mechanism selectively driving the spindle, the body having a forward end supporting the spindle; and
a battery connectable to the body and including a forward surface having an exterior side and a lower surface having an exterior side, the exterior side of the forward surface being oriented at an obtuse angle with respect to the exterior side of the lower surface.

9. The combination of claim 8, wherein the battery includes a forward-most point, and wherein the lower surface is spaced rearwardly from the forward-most point.

10. The combination of claim 8, further comprising a shoe support connected to the forward end of the body, and wherein, during sawing of a work piece, a forward-most portion of the saw blade and a lower-most portion of the shoe support are positionable against the work piece and the battery is spaced a distance from the work piece.

11. The combination of claim 10, wherein, during sawing of the work piece, at least a portion of the forward surface is substantially parallel to at least a portion of the work piece.

12. The combination of claim 8, wherein, during plunge-cutting, the battery is spaced a distance from a work piece.

13. The combination of claim 8, wherein the battery includes a second forward surface having an exterior side oriented at an obtuse angle with respect to the exterior side of the first forward surface.

14. A power tool comprising:
a spindle for supporting a tool element;
a body housing a motor and a drive mechanism driven by the motor, the drive mechanism selectively reciprocating the spindle relative to the body;
a counterweight supported in the body for reciprocating motion relative to the body along a travel path and having a slot extending between a forward end of the counterweight and a rearward end of the counterweight and opening inwardly toward the travel path.

15. The power tool of claim 14, wherein the drive assembly is a wobble plate drive assembly.

16. The power tool of claim 14, wherein the wobble plate drive assembly includes a first wobble plate connected to the spindle and a second wobble plate connected to the counterweight, and wherein the wobble plate drive assembly reciprocates the spindle and the counterweight in opposite directions.

17. The power tool of claim 14, wherein the counterweight is substantially U-shaped and defines an open interior portion, and wherein the slot opens toward the open interior portion.

18. The power tool of claim 14, further comprising a pair of substantially parallel rods extending through the body for supporting the counterweight for movement along the travel path.

19. The power tool of claim 14, wherein an opening extends through the counterweight between the forward end and the rearward end, and wherein one of the pair of rods extends through the slot and an other of the pair of rods extends through the opening.

20. The power tool of claim 14, wherein the counterweight includes a first leg and a second leg, wherein the slot extends through the first leg, and wherein an opening extends through the second leg in a direction substantially parallel to the travel path.
